(19) United States
(12) Patent Application Publication
(10) Pub. No.: US 2026/0072565 A1
(43) Pub. Date: Mar. 12, 2026

(54) DISPLAY DEVICE FOR DISPLAYING 3D IMAGES AND METHOD FOR OPERATING THE SAME

(71) Applicant: SAMSUNG DISPLAY CO., LTD., YONGIN-SI (KR)

(72) Inventors: Jae Uk CHOI, Yongin-si (KR); Ki Seo KIM, Yongin-si (KR); Young Sik KIM, Yongin-si (KR); In Nam LEE, Yongin-si (KR)

(21) Appl. No.: 19/238,650

(22) Filed: Jun. 16, 2025

(30) Foreign Application Priority Data
Sep. 9, 2024 (KR) 10-2024-0122657

(51) Int. Cl. G06F 3/04815; G02B 27/01

(52) U.S. Cl. CPC G06F 3/04815; G02B 27/0172; G02B 2027/0174; G02B 2027/0178

(57) ABSTRACT

Provided are a display device and a method for driving the same. A display device includes a display panel and a processor. The processor controls the display panel to display a designated guide image for setting three-dimensional (3D) touch coordinates in 3D space. The processor controls the display panel to display a guide message directing a user to touch a plurality of objects included in the guide image in sequence. When the user sequentially touches the plurality of objects, the processor records reference coordinates in the 3D space corresponding to the user's touches. Based on the recorded reference coordinates, the processor completes setting of 3D touch coordinates.

### CROSS-REFERENCE TO RELATED APPLICATION

This U.S. non-provisional patent publication application is related to and claims priority under 35 U.S.C. § 119 to Korean Patent Application No. 10-2024-0122657, filed on Sep. 9, 2024, the disclosure of which is incorporated by reference in its entirety herein.

### TECHNICAL FIELD

This disclosure relates generally to a display device and more particularly to a display device that displays three-dimensional (3D) images, and a method for operating the same.

### DISCUSSION OF RELATED ART

With advances in the information society, more and more demands are placed on display devices for displaying images in various ways. Some examples of display devices include a flat panel display device such as a liquid crystal display (LCD), a field emission display and a light emitting diode (LED) display. An example of an LED display is an organic light emitting diode (OLED) display device including an OLED element as a light emitting element. Another type of LED display device includes inorganic LEDs as the light emitting elements.

Recently, display devices that create three-dimensional (3D) images have been developed. To create 3D images, a glasses type method and a non-glasses type method have been developed and commercialized. The glasses type method includes a polarized glasses type method and a shutter glasses type method. The non-glasses type method includes a lenticular method and a parallax barrier method. These methods allow a user to view 3D images using the principle of binocular parallax. A 3D image display device for the purpose of delivering 3D images to the user should ideally deliver a realistic 3D experience that is indistinguishable from the 3D experience encountered by the user in a natural environment.

For the display device that creates 3D images, a new interface method that detects a user's touch or user's gesture with respect to 3D space is desirable, unlike a screen touch interface provided to the user by a flat panel display device.

### SUMMARY

Embodiments of the present disclosure provide a display device capable of detecting a user's touch or a user's gesture with respect to 3D space using an antenna built into a display panel, and a method for operating the same.

According to an embodiment of the present disclosure, a display device includes a display panel and a processor. The processor controls the display panel to display a designated guide image for setting three-dimensional (3D) touch coordinates in 3D space. The processor controls the display panel to display a guide message directing a user to touch a plurality of objects included in the guide image in sequence. When the user sequentially touches the plurality of objects, the processor records reference coordinates in the 3D space corresponding to the user's touches. Based on the recorded reference coordinates, the processor completes setting of 3D touch coordinates.

The guide image may include at least a portion of a cube-shaped image.

The guide image may include a first object corresponding to a first vertex of the cube shape and representing an origin in the 3D space, a second object corresponding to a second vertex of the cube shape and representing an X coordinate from the origin in the 3D space, a third object corresponding to a third vertex of the cube shape and representing a Y coordinate from the origin in the 3D space, and a fourth object corresponding to a fourth vertex of the cube shape and representing a Z coordinate from the origin in the 3D space.

The guide image may include a message that instructs the user to touch the first object, the second object, the third object, and the fourth object in a predetermined order.

The processor may set the origin of the 3D space based on detecting, using an antenna within a non-display area of the display panel, that the user has touched the first object.

The processor may set an X reference coordinate on the X coordinate based on detecting, using the antenna, that the user has touched the second object.

The processor may set a Y reference coordinate on the Y coordinate based on detecting, using the antenna, that the user has touched the third object.

The processor may set a Z reference coordinate on the Z coordinate based on detecting, using the antenna, that the user has touched the fourth object using the antenna.

The display device may be a glasses-type display.

The display device may be a non-glasses type light field display (LFD).

The display device may be a holographic display.

The display device may be a variable focus type volumetric display.

According to an embodiment of the present disclosure, a method for operating a display device including a display panel includes controlling, by a processor, the display panel to display a designated guide image for setting 3D touch coordinates in 3D space, controlling, by the processor, the display panel to display a guide message directing a user to touch a plurality of objects included in the guide image in sequence, recording, by the processor to a memory, reference coordinates in the 3D space corresponding to the user's touches when the user sequentially touches the plurality of objects, and completing, by the processor, setting of 3D touch coordinates based on the recorded reference coordinates.

According to an embodiment of the present disclosure, a display device includes: a display panel having a display area and a non-display area outside the display area, the non-display area including an antenna; an antenna circuit board connected to the antenna; and a processor connected to the antenna circuit board. The processor is configured to: control the display panel to display a designated guide image for setting 3D touch coordinates in 3D space; control the display panel to display a guide message directing a user to touch a plurality of objects included in the guide image in sequence; and control the antenna circuit board to transmit radio frequency (RF) signals through the antenna. When the user sequentially touches the plurality of objects, the processor receives signal information from the antenna circuit board corresponding to the transmitted RF signals which are reflected from the user and received by the antenna, and based on the signal information, records reference coordinates in the 3D space in a memory, corresponding to the user's touches.

According to an embodiment of the present disclosure, an electronic device includes a processor, a memory having stored application programs for execution by the processor, and a display device including a display panel. The processor controls the display panel to display a designated guide image for setting 3D touch coordinates in 3D space. The processor controls the display panel to display a guide message directing a user to touch a plurality of objects included in the guide image in sequence. When the user sequentially touches the plurality of objects, the processor records reference coordinates in the 3D space corresponding to the user's touches. Based on the recorded reference coordinates, the processor completes setting of 3D touch coordinates. The electronic device further includes a user interface configured to sense user input via touch or cursor selection of an icon presented on the display panel, or touch input detection in the 3D space. The processor executes one or more of the application programs upon receipt of the user input.

In the electronic device, the stored application programs may include one or more of a camera application, an audiovisual streaming application, or a telephone application.

In the electronic device, the user interface may be a touch screen embedded in the display panel, where the touch screen includes touch sensors for sensing a touch or a tap by a user. The user interface may further include an audio sensor embedded in the display panel, where the audio sensor may receive voice commands to establish access to one or more of the application programs.

With the display device, the electronic device, and the method for operating the same according to embodiments, a user's touch or user's gesture with respect to 3D space may be detected using an antenna built into a display panel.

### BRIEF DESCRIPTION OF THE DRAWINGS

The above and other features of the present disclosure will become more apparent by describing in detail embodiments thereof, with reference to the accompanying drawings, in which:

FIGS. 1 and 2 are plan views illustrating a display device according to an embodiment;

FIGS. 3 and 4 are side views illustrating a display device according to an embodiment;

FIGS. 5 and 6 are plan views illustrating a display device according to other embodiments;

FIG. 7 is a plan view illustrating an example of the antenna area of FIG. 1;

FIG. 8 is a cross-sectional view of a part of the display area of the display device according to an embodiment;

FIG. 9 is a cross-sectional view of a boundary between an antenna area of a display device according to an embodiment and a non-display area adjacent thereto;

FIG. 10 is a diagram illustrating an example in which a display device according to an embodiment is implemented as a non-glasses type light field display (LFD);

FIG. 11 is a diagram illustrating an example in which a display device according to an embodiment is implemented as a volumetric display;

FIG. 12 is a perspective view illustrating a head mounted display according to an embodiment;

FIG. 13 is an exploded perspective view illustrating an example of the head mounted display of FIG. 12;

FIG. 14 is a perspective view illustrating a head mounted display according to an embodiment;

FIG. 15 is a diagram illustrating an example in which a display device according to an embodiment is a holographic display;

FIG. 16 is a diagram illustrating an example in which a display device according to an embodiment is a glasses type display device;

FIG. 17 is a flowchart illustrating a method for driving a display device according to an embodiment;

FIG. 18 is a conceptual diagram illustrating a method of setting reference coordinates for 3D touch detection by a display device according to an embodiment;

FIG. 19 is an example of a coordinate system in which the display device according to an embodiment performs 3D touch detection; and

FIG. 20 is a block diagram of an electronic device according to an embodiment.

### DETAILED DESCRIPTION OF EMBODIMENTS

Embodiments of the present disclosure will be described more fully hereinafter with reference to the accompanying drawings. Like reference numerals may refer to like elements throughout the specification and the accompanying drawings.

Embodiments of the present disclosure present a user interface for 3D image display devices, which allows a user to select icons in 3D space with precision. Precise touch inputs are detectable in the 3D space through use of a calibration procedure that guides a user to touch points in space corresponding to specific points of a guide image. An antenna may be incorporated within a non-display area of the display device to detect the user's touch inputs using a radar-based method during the calibration procedure and subsequently during execution of an application program.

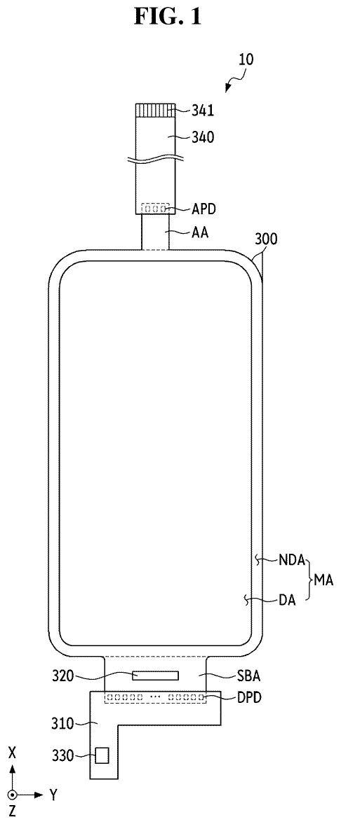

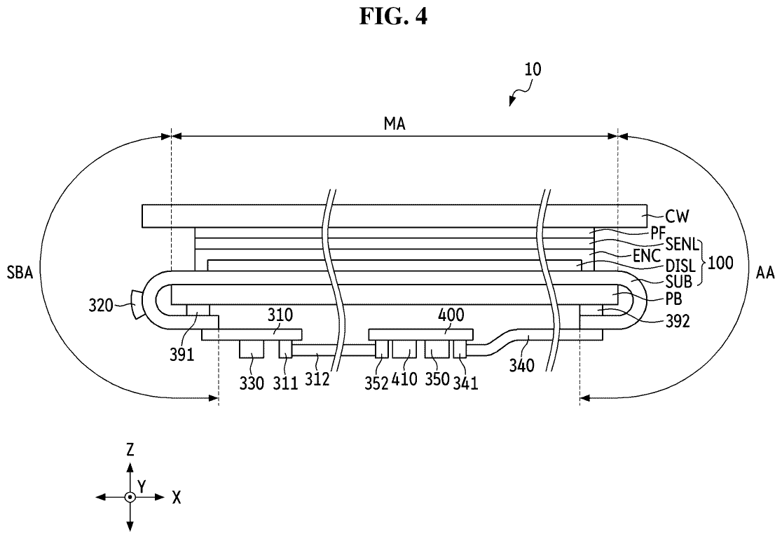

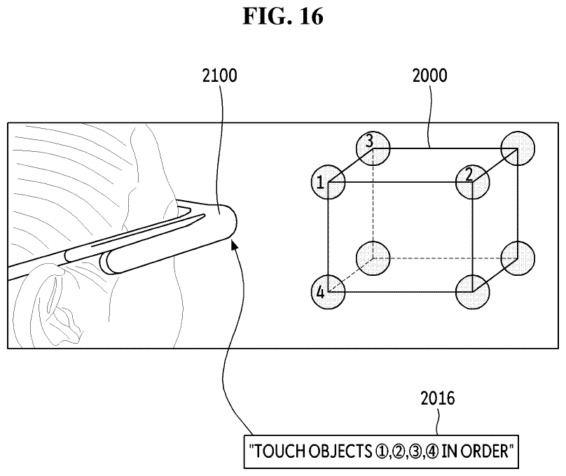

Accordingly, an embodiment of the inventive concept described hereafter provides a display device 10 (see FIG. 1) including a display panel (300) and a processor (410, FIG. 4). The processor may control the display panel to display a designated guide image (e.g., 2000, FIG. 16) for setting three-dimensional (3D) touch coordinates in 3D space. The processor may control the display panel to display a guide message (e.g., 2016, FIG. 16) directing a user to touch a plurality of objects (e.g., 2001-2004) included in the guide image in sequence. When the user sequentially touches the objects, the processor may record reference coordinates in the 3D space in a memory, corresponding to the user's touches. Based on the recorded reference coordinates, the processor may complete setting of 3D touch coordinates. Thus, a coordinate system in the 3D space may be precisely established for the display device in correspondence with a particular user. Applications that are subsequently run may then utilize the established 3D coordinate system to set up user-selectable icons in the 3D space with high precision.

Herein, when two or more elements or values are described as being substantially the same as or about equal to each other, it is to be understood that the elements or values are identical to each other, the elements or values are equal to each other within a measurement error, or if measurably unequal, are close enough in value to be functionally equal to each other as would be understood by a person having ordinary skill in the art. For example, the term “about” as used herein is inclusive of the stated value and means within an acceptable range of deviation for the particular value as determined by one of ordinary skill in the art, considering the measurement in question and the error associated with measurement of the particular quantity (e.g., the limitations of the measurement system). For example, “about” may mean within one or more standard deviations as understood by one of the ordinary skill in the art. Further, it is to be understood that while parameters may be described herein as having “about” a certain value, according to embodiments, the parameter may be exactly the certain value or approximately the certain value within a measurement error as would be understood by a person having ordinary skill in the art. Other uses of these terms and similar terms to describe the relationship between components should be interpreted in a like fashion.

It will be understood that when a component, such as a film, a region, a layer, or an element, is referred to as being “on”, “connected to”, “coupled to”, or “adjacent to” another component, it can be directly on, connected, coupled, or adjacent to the other component, or intervening components may be present. It will also be understood that when a component is referred to as “covering” another component, it can be the only component covering the other component, or one or more intervening components may also be covering the other component. Other words used to describe the relationship between elements may be interpreted in a like fashion.

It will be further understood that descriptions of features or aspects within each embodiment are available for other similar features or aspects in other embodiments, unless the context clearly indicates otherwise. Accordingly, all features and structures described herein may be mixed and matched in any desirable manner.

As used herein, the singular forms “a”, “an” and “the” are intended to include the plural forms as well, unless the context clearly indicates otherwise.

When a feature is said to extend, protrude, or otherwise follow a certain direction, it will be understood that the feature may follow said direction in the negative, i.e., opposite direction. Accordingly, the feature is not limited to follow exactly one direction, but may follow along an axis formed by the direction, unless the context clearly indicates otherwise.

Hereinafter, embodiments of the present disclosure will be described in detail with reference to the accompanying drawings.

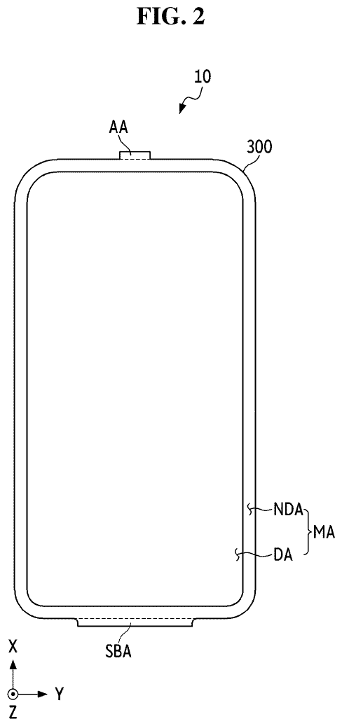

FIGS. 1 and 2 are plan views illustrating a display device according to an embodiment.

Referring to FIGS. 1 and 2, a display device 10 according to an embodiment may be applied to portable electronic devices such as a mobile phone, a smartphone, a tablet personal computer, a mobile communication terminal, an electronic organizer, an electronic book, a portable multimedia player (PMP), a navigation system, an ultra mobile PC (UMPC) or the like. Alternatively, the display device 10 may be applied as a display unit of a television, a laptop, a monitor, a billboard, or an Internet-of-Things (IoT) terminal. Alternatively, the display device 10 according to an embodiment may be applied to wearable devices such as a smart watch, a watch phone, a glasses type display, or a head mounted display (HMD). Alternatively, the display device 10 may be applied to a dashboard of a vehicle, a center fascia of a vehicle, a center information display (CID) disposed on a dashboard of a vehicle, a room mirror display in place of side mirrors of a vehicle, or a display disposed on a rear surface of a front seat for rear seat entertainment of a vehicle.

In the present disclosure, a first direction (X-axis direction) may be a long side direction of the display device 10, for example, a vertical direction of the display device 10. A second direction (Y-axis direction) may be a short side direction of the display device 10, for example, a horizontal direction of the display device 10. A third direction (Z-axis direction) may be a thickness direction of the display device 10. The corner where the long side in the first direction (X-axis direction) and the short side in the second direction (Y-axis direction) meet may be rounded to have a selected curvature or may be right-angled.

The display device 10 includes a display panel 300, a display circuit board 310, a display driving circuit 320, a touch driving circuit 330, and an antenna circuit board 340. A connector 341 may be formed on one side of the antenna circuit board 340.

The display panel 300 may be a light emitting display panel including a light emitting element. For example, the display panel 300 may be an organic light emitting display panel using an organic light emitting diode including an organic light emitting layer, a micro light emitting diode display panel using a micro LED, a quantum dot light emitting display panel using a quantum dot light emitting diode including a quantum dot light emitting layer, or an inorganic light emitting display panel using an inorganic light emitting element including an inorganic semiconductor.

The display panel 300 may be a flexible display panel that is flexible and may be easily bent, folded, or rolled. For example, the display panel 300 may be a foldable display panel which can be folded and unfolded, a curved display panel having a curved display surface, a bendable display panel having a bent area other than the display surface, a rollable display panel which can be rolled up and rolled out, or a stretchable display panel which can be stretched.

The display panel 300 may include a main region MA, a sub-region SBA protruding from one side of the main region MA, and an antenna area AA protruding from the other side of the main region MA. The antenna area AA may be referred to as a “protrusion area.”

The main region MA may include the display area DA displaying an image and the non-display area NDA that is a peripheral area of the display area DA. The display area DA may occupy most of the main region MA. The display area DA may be disposed at the center of the main region MA. The non-display area NDA may be an area outside the display area DA. The non-display area NDA may be defined as an edge area of the display panel 300. The non-display area NDA may be referred to as a dead space area DS.

The sub-region SBA may protrude in the first direction (X-axis direction) from one side of the main region MA. For example, one side of the main region MA may be a lower side of the main region MA. As illustrated in FIG. 1, the length of the sub-region SBA in the first direction (X-axis direction) may be smaller than the length of the main region MA in the first direction (X-axis direction), and the length of the sub-region SBA in the second direction (Y-axis direction) may be smaller than the length of the main region MA in the second direction (Y-axis direction), but the embodiment of the present disclosure is not limited thereto.

Referring to FIG. 2, the sub-region SBA may be bent, and at least a part of the bent sub-region SBA may be disposed under the display panel 300. In this case, at least a part of the sub-region SBA may overlap the main region MA of the display panel 300 in the third direction (Z-axis direction).

Display pads DPD may be disposed at one side edge of the sub-region SBA. One side edge of the sub-region SBA may be a lower side edge of the sub-region SBA. The display circuit board 310 may be attached to the display pads DPD of the sub-region SBA. The display circuit board 310 may be attached to the display pads DPD of the sub-region SBA by using a conductive adhesive member such as an anisotropic conductive film or an anisotropic conductive paste. The display circuit board 310 may be a flexible printed circuit board (FPCB) which is bendable, a rigid printed circuit board (PCB) which is solid to be hardly bent, or a composite printed circuit board having both of the rigid printed circuit board and the flexible printed circuit board.

The display driving circuit 320 may be disposed on the sub-region SBA of the display panel 300. The display driving circuit 320 may receive control signals and power voltages, and generate and output signals and voltages for driving the display panel 300. The display driving circuit 320 may be formed as an integrated circuit (IC).

A touch driving circuit 330 may be disposed on the display circuit board 310. The touch driving circuit 330 may be formed as an integrated circuit. The touch driving circuit 330 may be attached to the display circuit board 310.

The touch driving circuit 330 may be electrically connected to sensor electrodes of a sensor electrode layer of the display panel 300 through the display circuit board 310. The touch driving circuit 330 may output a touch driving signal to each of the sensor electrodes, and may sense a voltage change according to mutual capacitance of the sensor electrodes.

The sensor electrode layer of the display panel 300 may sense a proximity touch and/or a contact touch. The contact touch means that the object such as the human finger or pen makes a direct contact with the cover window disposed above the sensor electrode layer. The proximity touch means that the object such as the human finger or pen is positioned above the cover window to be proximately apart therefrom, such as hovering.

A power supply unit for supplying driving voltages for driving the display pixels of the display panel 300 and the display driving circuit 320 may be additionally disposed on the display circuit board 310. Alternatively, the power supply unit may be integrated with the display driving circuit 320, and in this case, the display driving circuit 320 and the power supply unit may be formed as a single integrated circuit.

The antenna area AA may be an area including at least one component among an antenna electrode, a feed line, and a ground line of an antenna module for wireless communication. The antenna area AA may protrude from the other side of the main region MA in the first direction (X-axis direction). For example, the other side of the main region MA may be an upper side of the main region MA. As illustrated in FIG. 1, the length of the antenna area AA in the first direction (X-axis direction) may be smaller than the length of the main region MA in the first direction (X-axis direction), and the length of the antenna area AA in the second direction (Y-axis direction) may be smaller than the length of the main region MA in the second direction (Y-axis direction), but the embodiment of the present disclosure is not limited thereto.

As illustrated in FIG. 2, at least a part of the antenna area AA may be bent, and at least a part of the bent antenna area AA may be disposed under the display panel 300. In this case, at least a part of the antenna area AA may overlap the main region MA of the display panel 300 in the third direction (Z-axis direction).

Antenna pads APD may be disposed at one side edge of the antenna area AA. The antenna circuit board 340 may be attached to the antenna pads APD of the antenna area AA. The antenna circuit board 340 may be attached to the antenna pads APD of the antenna area AA by using a conductive adhesive member such as an anisotropic conductive film and an anisotropic conductive adhesive. One side of the antenna circuit board 340 may include the connector 341 connected to a main circuit board 400 on which an antenna driving circuit 350 (see FIG. 4) is mounted. The antenna circuit board 340 may be a flexible printed circuit board (FPCB) that may be bent.

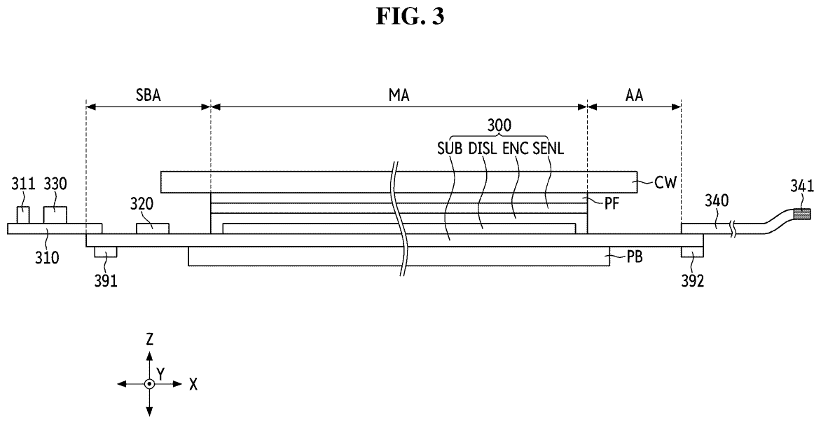

FIGS. 3 and 4 are side views illustrating a display device according to an embodiment.

Referring to FIGS. 3 and 4, the display device 10 according to an embodiment may include the display panel 300, a polarizing film PF, a cover window CW, and a panel lower cover PB. The display panel 300 may include a substrate SUB, a display layer DISL, an encapsulation layer ENC, and a sensor electrode layer SENL.

The substrate SUB may be formed of an insulating material such as polymer resin. The substrate SUB may be a flexible substrate which can be bent, folded or rolled.

The display layer DISL may be disposed on the main region MA of the substrate SUB. The display layer DISL may be a layer that displays an image by including emission areas. The display layer DISL may include a thin film transistor layer in which thin film transistors are formed, and a light emitting element layer in which light emitting elements emitting light are disposed in emission areas.

In the display area DA of the display layer DISL, not only emission areas but also scan lines, data lines, power lines, and the like for driving light emitting elements in the emission areas may be disposed. In the non-display area NDA of the display layer DISL, a scan driver outputting scan signals to the scan lines, fan-out lines connecting the data lines and the display driving circuit 320, and the like may be disposed.

The encapsulation layer ENC may be disposed on the display layer DISL. The encapsulation layer ENC may be a layer for encapsulating the light emitting element layer of the display layer DISL to prevent permeation of oxygen or moisture into the light emitting element layer of the display layer DISL. The encapsulation layer ENC may be disposed on the top surfaces and the side surfaces of the display layer DISL.

The sensor electrode layer SENL may be disposed on the display layer DISL. The sensor electrode layer SENL may include sensor electrodes. The sensor electrode layer SENL may sense a touch using sensor electrodes.

The polarizing film PF may be disposed on the sensor electrode layer SENL. The polarizing film PF may include a first base member, a linear polarization plate, a phase retardation film such as a quarter-wave plate (λ/4 plate), and a second base member. The first base member, the phase retardation film, the linear polarization plate, and the second base member may be sequentially stacked on the sensor electrode layer SENL.

The cover window CW may be disposed on the polarizing film PF. The cover window CW may be attached onto the polarizing film PF by a transparent adhesive member such as an optically clear adhesive (OCA) film.

The panel lower cover PB may be disposed under the display panel 300. The panel lower cover PB may be attached to the bottom surface of the display panel 300 through an adhesive member. The adhesive member may be a pressure sensitive adhesive (PSA). The panel lower cover PB may include at least one of a light blocking member for absorbing light incident from the outside, a buffer member for absorbing an impact from the outside, or a heat dissipation member for efficiently dissipating heat from the display panel 300.

The light blocking member may be disposed under the display panel 300. The light blocking member blocks light transmission, thereby preventing components (e.g., the display circuit board 310 and the like) disposed under the light blocking member from being viewed from the top of the display panel 300. The light blocking member may include a light absorbing material such as a black pigment, black dyes or the like.

The buffer member may be disposed under the light blocking member. The buffer member absorbs an external impact to prevent the display panel 300 from being damaged. The buffer member may be formed of a single layer or multiple layers. For example, the buffer member may be formed of a polymer resin such as polyurethane (PU), polycarbonate (PC), polypropylene (PP), or polyethylene (PE) or may include an elastic material such as a foamed sponge obtained from rubber, a urethane-based material, or an acrylic material.

The heat dissipation member may be disposed under the buffer member. Some examples of the heat dissipation member may include a first heat dissipation layer containing graphite, carbon nanotubes or the like, and a second heat dissipation layer formed of a metal thin film containing, for example, copper, nickel, ferrite, or silver which can shield electromagnetic waves and has excellent thermal conductivity.

As illustrated in FIG. 4, the sub-region SBA of the substrate SUB may be bent and disposed below the display panel 300. The sub-region SBA of the substrate SUB may be attached to the bottom surface of the panel lower cover PB by a first adhesive member 391. The first adhesive member 391 may be a pressure sensitive adhesive.

As illustrated in FIG. 4, the antenna area AA of the substrate SUB may be bent and disposed below the display panel 300. The antenna area AA of the substrate SUB may be attached to the bottom surface of the panel lower cover PB by a second adhesive member 392. The second adhesive member 392 may be a pressure sensitive adhesive.

The display circuit board 310 may be attached to the display pads DPD of the sub-region SBA of the substrate SUB by using a conductive adhesive member such as an anisotropic conductive film or an anisotropic conductive adhesive. The display circuit board 310 may include a connector 311 connected to a flexible printed circuit board 312. The display circuit board 310 may be connected to a connector 352 of the main circuit board 400 through the flexible printed circuit board 312.

The touch driving circuit 330 may be disposed on the display circuit board 310. The touch driving circuit 330 may generate touch data according to changes in electrical signals sensed by each of the sensor electrodes of the sensor electrode layer of the display panel 300 and transmit the touch data to a main processor 410 of the main circuit board 400, and the main processor 410 may calculate a touch coordinate in which a touch occurs by analyzing the touch data.

The antenna circuit board 340 may be attached to the antenna pads APD of the antenna area AA of the substrate SUB by using a conductive adhesive member such as an anisotropic conductive film or an anisotropic conductive adhesive. A connector 351 of the antenna circuit board 340 may be connected to the connector 351 of the main circuit board 400. The antenna area AA may be connected to the main circuit board 400 by the antenna circuit board 340.

The main circuit board 400 may be a rigid printed circuit board (PCB) that is hard and does not easily bend. The main processor 410 and the antenna driving circuit 350 may be disposed on the main circuit board 400.

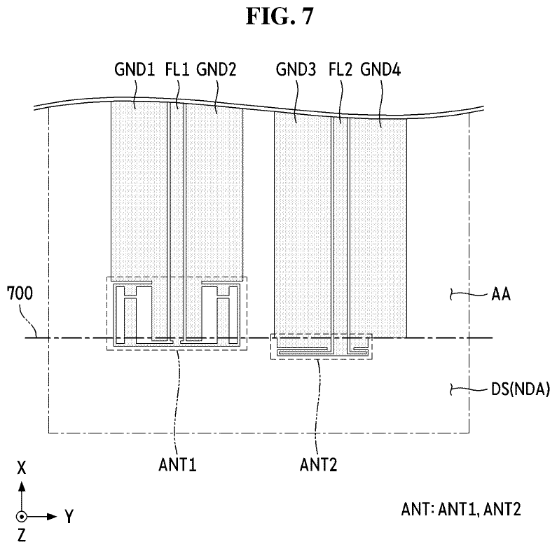

The antenna driving circuit 350 may be electrically connected to an antenna ANT, which may include antennas ANT1 and ANT2 (see FIG. 7) of the display panel 300, through the antenna circuit board 340. In some embodiments, antennas ANT1 and ANT2 are antenna elements of a multi-element antenna array, and each is used for at least receiving reflected RF signals. In other embodiments, one of the antennas ANT1 and ANT2 is used for transmitting signals towards the user and the other is used for receiving reflected signals from the user.

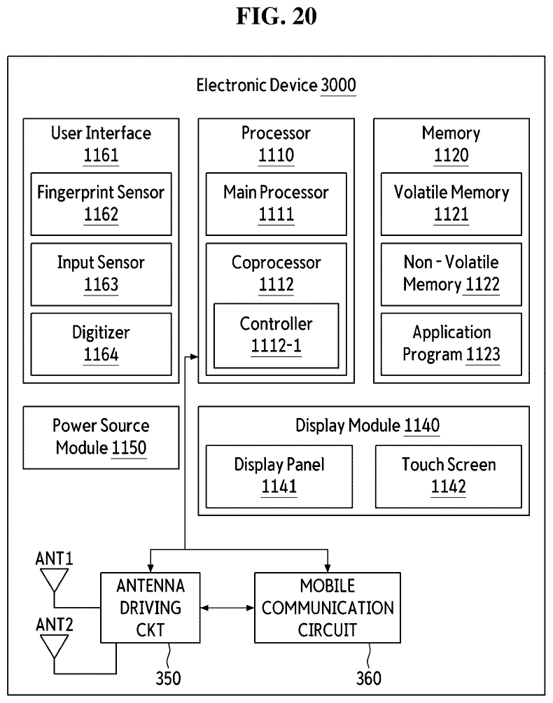

To determine coordinates of a user's touch inputs in 3D space, a radar operation may be implemented in conjunction with (e.g., simultaneously with) beamforming and beam steering. In the radar operation, RF signals may be transmitted from the antenna ANT1 and/or the antenna ANT2 to free space towards a user, and the timing of reflected signals from the user may be compared with the timing of the transmitted signals to determine a distance from the user's touch input (touching an image of an object in 3D space) to the antennas ANT1 and ANT2. Here, the “touch input” may be a user's fingertip or an item held by the user that reflects RF energy. Further, using beamforming and beam steering, the direction of the touch input relative to the antennas ANT1 and ANT2 may be determined to complete a determination of the coordinates of the touch input. To this end, the phase (and/or amplitude) of a signal transmitted from antenna ANT1 may be adjusted relative to that of the same signal transmitted from antenna ANT2 to form a beam and steer the beam to a desired direction. The phase/amplitude adjustment may be controlled by the processor 410 by controlling phase shifters and/or amplitude adjusters (not shown) within the antenna driving circuit 350 or a mobile communication circuit (“module”) 360 (shown in FIG. 20). Thus, the processor 410 may be described as “controlling an antenna” when the processor controls phase shifters and/or amplitude adjusters for beamforming and beam steering. Reflections for different beam positions may then be analyzed by the processor 410. Among the reflections, a reflection corresponding to that expected (e.g., based on prior experimentation) from a user with an extended finger or holding a signal reflecting object may then be detected to determine the touch input's direction in 3D space relative to the antennas ANT1 and ANT2. Thereby, the touch coordinates may be finally determined based on the distance and direction of the touch input relative to the antennas ANT1 and ANT2.

Accordingly, in a receiving path, the antenna driving circuit 350 may receive RF signals (interchangeably, “electromagnetic wave signals”) through the antennas ANT1 and ANT2, and in a transmitting path the antenna driving circuit 350 may output RF signals to be transmitted through the antennas ANT1 and ANT2 to free space. The antenna circuit board 340 may be formed of an integrated circuit (IC).

The antenna driving circuit 350 may process RF signals transmitted and received through the antennas ANT1 and ANT2. For example, the antenna driving circuit 350 may change the amplitude of an RF signal received by antennas ANT1 and ANT2 using a low noise amplifier and/or an attenuator. Alternatively or additionally, the antenna driving circuit 350 may change the phase as well as the amplitude of the RF signal received by the antennas ANT1 and ANT2. In the receive path, the antenna driving circuit 350 may route the processed RF signal to a mobile communication circuit (“module”) 360 (shown in FIG. 20) which may be connected to the processor 410. The mobile communication circuit 360 may be disposed on the main circuit board 400 and may include, e.g., in the transmit path, circuitry for modulating and upconverting baseband signals to RF signals, and in the receive path, circuitry for demodulating and downconverting RF signals to baseband signals (an example of “signal information”). The mobile communication circuit 360 may further include an analog to digital (A/D) converter in the receive path to convert the baseband signals to digital data (another example of “signal information”) which are provided to the processor 410 for signal processing analysis.

In the transmit path, the antenna driving circuit 350 may change the amplitude of the RF signals transmitted from the mobile communication circuit 360 using a power amplifier and optionally a variable attenuator, both of which may be controlled by the processor 410. Alternatively or additionally, as noted above, the antenna driving circuit 350 may change the phase of the RF signal transmitted from the mobile communication circuit 360. The antenna driving circuit 350 may transmit the processed RF signals to the antennas ANT1 and ANT2. The antenna driving circuit 350 may be an RF front end that may further include filters, a transmit/receive (T/R) switch, impedance matching circuitry, etc. It is noted here that in some embodiments, instead of using antennas ANT1 and ANT2 for both transmitting and receiving, another antenna (not shown) within the display device may be used for the transmitting operations.

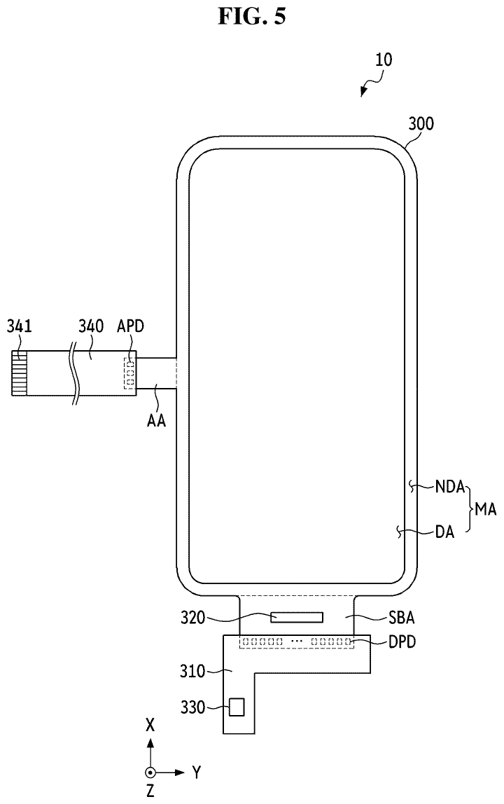

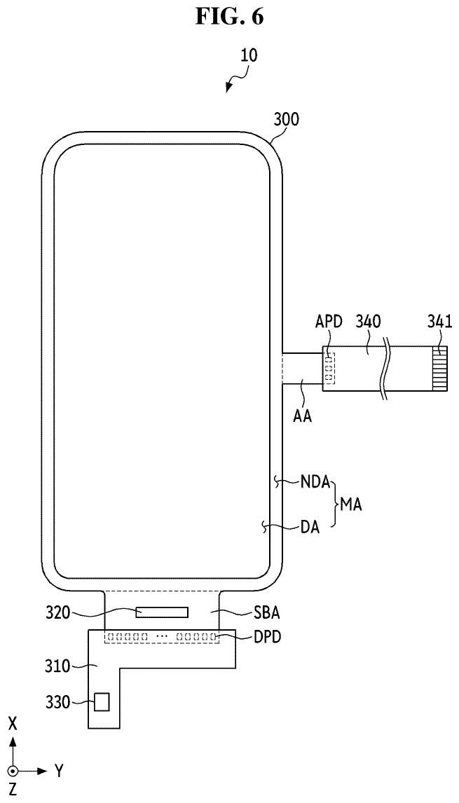

FIG. 5 is a plan view illustrating a display device according to another embodiment. FIG. 6 is a plan view illustrating a display device according to still another embodiment.

The embodiment of FIG. 5 is different from the embodiments of FIGS. 1 and 2 in that the antenna area AA protrudes from the left side of the main region MA in the second direction (Y-axis direction). The embodiment of FIG. 6 is different from the embodiments of FIGS. 1 and 2 in that the antenna area AA protrudes from the right side of the main region MA in the second direction (Y-axis direction). In FIGS. 5 and 6, redundant description of parts already described in the embodiment of FIGS. 1 and 2 will be omitted.

As illustrated in FIGS. 5 and 6, the antenna area AA may protrude from one side of the main region MA, and one side of the main region MA may be one of the upper side, the lower side, the left side, and the right side of the main region MA.

In some embodiments, the antenna area AA may protrude from the lower side of the main region MA in the second direction (Y-axis direction), and the antenna area AA may be disposed to be spaced apart from the sub-region SBA in the second direction (Y-axis direction). In this case, the length of the antenna area AA in the first direction (X-axis direction) may be smaller than the length of the sub-region SBA in the first direction (X-axis direction), and the length of the antenna area AA in the second direction (Y-axis direction) may be smaller than the length of the sub-region SBA in the second direction (Y-axis direction), but embodiments are not limited thereto.

FIG. 7 is a plan view illustrating an example of the antenna area AA of FIG. 1.

In FIG. 7, a dotted line 700 is an imaginary boundary line dividing the antenna area AA and the dead space area DS, which is at least part of the non-display area NDA. In the illustrated example, an area positioned on the upper side of the dotted line 700 represents a part of the antenna area AA, and an area positioned on the lower side of the dotted line 700 represents a part of the dead space area DS.

According to an embodiment, the display device 10 includes an antenna ANT comprising a first antenna ANT1 and a second antenna ANT2. As mentioned earlier, the first antenna ANT1 and the second antenna ANT2 may be antenna elements of a two or higher element array that may be driven with variable relative phase/amplitude to produce a steerable beam. The steerable beam may be used to more accurately detect coordinates of a user's touch input in 3D space.

The first antenna ANT1 may be disposed on the boundary between the antenna area AA and the dead space area DS, and may be connected to a first feed line FL1, a first ground line GND1, and a second ground line GND2 formed in the antenna area AA. The first feed line FL1 may be disposed between the first ground line GND1 and the second ground line GND2, and thus may have a ground coplanar waveguide (GCPW) structure. Alternatively, the first feed line FL1 may have a coplanar waveguide (CPW) structure.

The extension direction of each of the first feed line FL1, the first ground line GND1, and the second ground line GND2 may be the same as the extension direction of the antenna area AA, and they may be electrically connected to the antenna pads APD (see FIG. 1). For example, each of the first feed line FL1, the first ground line GND1, and the second ground line GND2 may extend in the first direction (X-axis direction), and each end thereof may be connected to the first antenna ANT1.

Referring to FIG. 7, the first antenna ANT1 may be disposed from a part of the dead space area DS to a part of the antenna area AA. For example, a part of the first antenna ANT1 may be disposed in the antenna area AA adjacent to the dead space area DS, and the remaining portion of the first antenna ANT1 may be disposed in the dead space area DS adjacent to the antenna area AA. However, the area in which the first antenna ANT1 is disposed is not limited to the example of FIG. 7. For example, the first antenna ANT1 may be disposed in the dead space area DS adjacent to the antenna area AA. In addition, although not illustrated, the first antenna ANT1 may be disposed in a part of the antenna area AA adjacent to the dead space area DS.

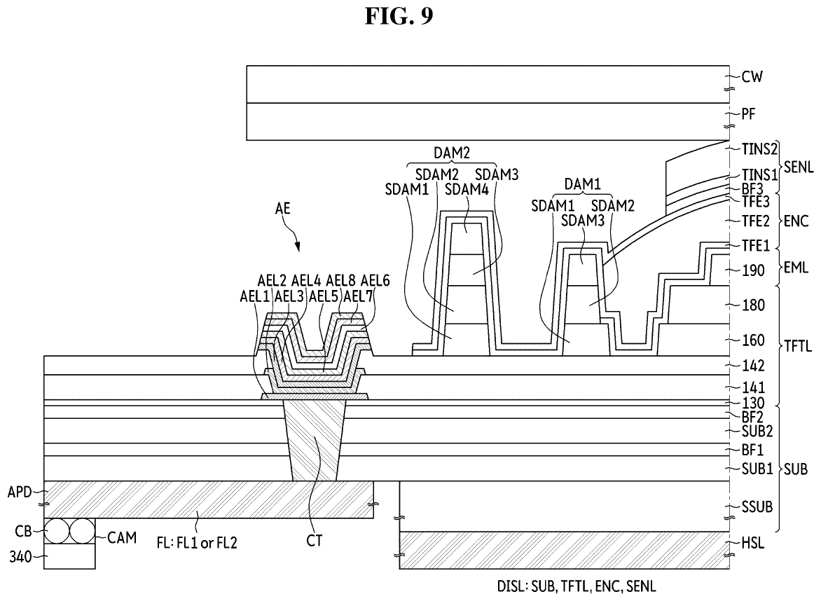

The width of the first antenna ANT1 may be designed to be equal to or less than a half-wavelength length for about 28 GHz (e.g., equal to or less than about 4.8 mm), and optimization of the resonance point of the structure for about 28 GHz may be adjusted through tuning of the width or the length of antenna electrodes AE (see FIG. 9) of the first antenna ANT1.

The first antenna ANT1 may have a structure of a half-wavelength slot antenna, and may generate a field parallel to the first direction (X-axis direction) through an LC parallel type structure or a loop type structure at both end portions thereof in the second direction (Y-axis direction). The first antenna ANT1 may have an antenna structure symmetrical with respect to the first feed line FL1.

The second antenna ANT2 may be disposed in the dead space area DS adjacent to the antenna area AA, and may be connected to a second feed line FL2, a third ground line GND3, and a fourth ground line GND4 formed in the antenna area AA. The second feed line FL2 may be disposed between the third ground line GND3 and the fourth ground line GND4, and thus may have a ground coplanar waveguide (GCPW) structure. Alternatively, the second feed line FL2 may have a coplanar waveguide (CPW) structure.

The extension direction of each of the second feed line FL2, the third ground line GND3, and the fourth ground line GND4 may be the same as the extension direction of the antenna area AA, and they may be electrically connected to the antenna pads APD (see FIG. 1). For example, each of the second feed line FL2, the third ground line GND3, and the fourth ground line GND4 may extend in the first direction (X-axis direction), and each end thereof may be connected to the second antenna ANT2.

Referring to FIG. 7, the second antenna ANT2 may be disposed in the dead space area DS adjacent to the antenna area AA, but the area in which the second antenna ANT2 is disposed is not limited to the illustrated example. For example, the second antenna ANT2 may be disposed in a part of the antenna area AA adjacent to the dead space area DS.

The second antenna ANT2 may have a structure of a modified dipole antenna, which is folded within the same length as the polarization structure of the first antenna ANT1. The second antenna ANT2 may have an asymmetrical antenna structure with respect to the second feed line FL2 to generate a field in the second direction (Y-axis direction) perpendicular to the first direction (X-axis direction).

The present disclosure describes the first antenna ANT1 and the second antenna ANT2 disposed in the non-display area NDA of the display panel 300 with reference to FIG. 7, but the antenna of the display panel 300 is not limited thereto. For example, the shape of the antenna of the display panel 300 is not limited, and it is configured to sense an RF signal reflected by an object (body). The antenna of the display panel 300 is configured to sense information such as a distance to an object (body) and a moving speed and direction thereof. For instance, the antenna may be used to implement radar-based measurement of a user's finger position or user-held signal reflecting object, in which a radar signal is transmitted from the antenna ANT and signals reflected from the user's finger or object are received by the antenna ANT and provided to the processor 410.

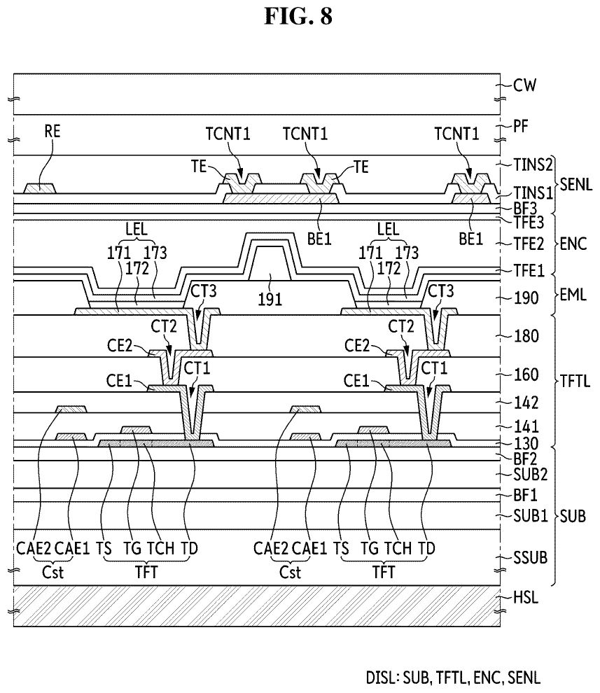

FIG. 8 is a cross-sectional view of a part of the display area of the display device according to an embodiment. For example, FIG. 8 may be a cross-sectional view of a part of the display panel 300 described with reference to FIGS. 1 to 6.

Referring to FIG. 8, the display panel 300 may include the substrate SUB, the display layer DISL having a thin film transistor layer TFTL and a light emitting element layer EML may be disposed on one surface of the substrate SUB, the encapsulation layer ENC may be disposed on the display layer DISL, and the sensor electrode layer SENL having sensor electrodes SE may be disposed on the encapsulation layer ENC. The polarizing film PF may be disposed on the sensor electrode layer SENL, and the cover window CW may be disposed on the polarizing film PF.

The substrate SUB may include a support substrate SSUB, a first substrate SUB1, a first buffer film BF1, a second substrate SUB2, and a second buffer film BF2. The first substrate SUB1 may be disposed on the support substrate SSUB, the first buffer film BF1 may be disposed on the first substrate SUB1, the second substrate SUB2 may be disposed on the first buffer film BF1, and the second buffer film BF2 may be disposed on the second substrate SUB2.

The support substrate SSUB may be a rigid substrate for supporting the first substrate SUB1 and the second substrate SUB2 that are flexible. The support substrate SSUB may be formed of glass or a plastic material such as polycarbonate (PC) and polyethylene terephthalate (PET).

The first substrate SUB1 and the second substrate SUB2 may be formed of an organic material such as acryl resin, epoxy resin, phenolic resin, polyamide resin, polyimide resin and the like. The first substrate SUB1 and the second substrate SUB2 may be formed of the same organic material or different organic materials.

Each of the first buffer film BF1 and the second buffer film BF2 may be formed of an inorganic material such as a silicon nitride layer, a silicon oxynitride layer, a silicon oxide layer, a titanium oxide layer and an aluminum oxide layer. Alternatively, each of the first buffer film BF1 and the second buffer film BF2 may be formed of a multilayer in which a plurality of layers of a silicon nitride layer, a silicon oxynitride layer, a silicon oxide layer, a titanium oxide layer and an aluminum oxide layer are alternately stacked. The first buffer film BF1 and the second buffer film BF2 may be formed of the same inorganic material or different inorganic materials.

An active layer ACT including a channel region TCH, a source region TS, and a drain region TD of a thin film transistor TFT may be disposed on the second buffer film BF2. The active layer ACT may include polycrystalline silicon, monocrystalline silicon, low-temperature polycrystalline silicon, amorphous silicon, or an oxide semiconductor material. When the active layer ACT includes polycrystalline silicon or an oxide semiconductor material, the source region TS and the drain region TD of the active layer ACT may be conductive regions doped with ions and having conductivity.

A gate insulating film 130 may be formed on the active layer ACT of the thin film transistor TFT. The gate insulating film 130 may be formed of an inorganic film, for example, a silicon nitride layer, a silicon oxynitride layer, a silicon oxide layer, a titanium oxide layer, or an aluminum oxide layer.

A first capacitor electrode CAE1 and a gate electrode TG of the thin film transistor TFT may be disposed on the gate insulating film 130. The gate electrode TG of the thin film transistor TFT may overlap the channel region TCH in the third direction (Z-axis direction). The gate electrode TG and the first capacitor electrode CAE1 may be formed of a single layer or multiple layers made of any one of molybdenum (Mo), aluminum (Al), chromium (Cr), gold (Au), titanium (Ti), nickel (Ni), neodymium (Nd) and copper (Cu) or an alloy thereof.

A first interlayer insulating film 141 may be disposed on the gate electrode TG and the first capacitor electrode CAE1. The first interlayer insulating film 141 may be formed of an inorganic film, for example, a silicon nitride layer, a silicon oxynitride layer, a silicon oxide layer, a titanium oxide layer, or an aluminum oxide layer. The first interlayer insulating film 141 may include a plurality of inorganic films.

A second capacitor electrode CAE2 may be disposed on the first interlayer insulating film 141. The second capacitor electrode CAE2 may overlap the first capacitor electrode CAE1 in the third direction (Z-axis direction). Therefore, a capacitor Cst may be formed by the first capacitor electrode CAE1 and the second capacitor electrode CAE2. An inorganic insulating dielectric layer is disposed between the first capacitor electrode CAE1 and the second capacitor electrode CAE2 to serve as a dielectric layer. The second capacitor electrode CAE2 may be formed of a single layer or multiple layers made of any one of molybdenum (Mo), aluminum (Al), chromium (Cr), gold (Au), titanium (Ti), nickel (Ni), neodymium (Nd) and copper (Cu), or an alloy thereof.

A second interlayer insulating film 142 may be disposed on the second capacitor electrode CAE2. The second interlayer insulating film 142 may be formed of an inorganic film, for example, a silicon nitride layer, a silicon oxynitride layer, a silicon oxide layer, a titanium oxide layer, or an aluminum oxide layer. The second interlayer insulating film 142 may include a plurality of inorganic films.

A first connection electrode CE1 may be disposed on the second interlayer insulating film 142. The first connection electrode CE1 may be connected to the drain region TD through a first contact hole CT1 penetrating the gate insulating film 130, the first interlayer insulating film 141, and the second interlayer insulating film 142. The first connection electrode CE1 may be formed of a single layer or multiple layers made of any one of molybdenum (Mo), aluminum (Al), chromium (Cr), gold (Au), titanium (Ti), nickel (Ni), neodymium (Nd) and copper (Cu), or an alloy thereof.

A first organic film 160 may be disposed on the first connection electrode CE1 to flatten a stepped portion formed by the thin film transistors TFT. The first organic film 160 may be formed of an organic film such as acryl resin, epoxy resin, phenolic resin, polyamide resin, polyimide resin and the like.

A second connection electrode CE2 may be disposed on the first organic film 160. The second connection electrode CE2 may be connected to the first connection electrode CE1 through a second contact hole CT2 penetrating the first organic film 160. The second connection electrode CE2 may be formed of a single layer or multiple layers made of any one of molybdenum (Mo), aluminum (Al), chromium (Cr), gold (Au), titanium (Ti), nickel (Ni), neodymium (Nd) and copper (Cu), or an alloy thereof.

A second organic film 180 may be disposed on the second connection electrode CE2. The second organic film 180 may be formed of an organic film such as acryl resin, epoxy resin, phenolic resin, polyamide resin, polyimide resin and the like.

The light emitting element layer EML is disposed on the thin film transistor layer TFTL. The light emitting element layer EML may include light emitting elements LEL and a bank 190.

Each of the light emitting elements LEL may include a pixel electrode 171, a light emitting layer 172, and a common electrode 173. Each of emission areas EA1, EA2, EA3, and EA4 represents an area in which the pixel electrode 171, the light emitting layer 172, and the common electrode 173 are sequentially stacked, and holes from the pixel electrode 171 and electrons from the common electrode 173 are combined with each other in the light emitting layer 172 to emit light. In this case, the pixel electrode 171 may be an anode electrode, and the common electrode 173 may be a cathode electrode.

The pixel electrode 171 may be formed on the second organic film 180. The pixel electrode 171 may be connected to a first connection electrode ANDE1 through a third contact hole CT3 penetrating the second organic film 180.

In a top emission structure that emits light toward the common electrode 173 with respect to the light emitting layer 172, the pixel electrode 171 may be formed of a single layer of molybdenum (Mo), titanium (Ti), copper (Cu), or aluminum (Al), or may be formed to have a stacked structure (Ti/Al/Ti) of aluminum and titanium, a stacked structure (ITO/Al/ITO) of aluminum and ITO, an APC alloy, or a stacked structure (ITO/APC/ITO) of APC alloy and ITO to increase the reflectivity. The APC alloy is an alloy of silver (Ag), palladium (Pd) and copper (Cu).

The bank 190 serves to define the emission areas EA1, EA2, EA3, and EA4 of the display pixels. To this end, the bank 190 may be formed to expose a partial region of the pixel electrode 171 on the second organic film 180. The bank 190 may cover the edge of the pixel electrode 171. The bank 190 may be disposed in a contact hole penetrating the second organic film 180. Therefore, the third contact hole CT3 penetrating the second organic film 180 may be filled with the bank 190. The bank 190 may be formed of an organic film such as acryl resin, epoxy resin, phenolic resin, polyamide resin, polyimide resin and the like.

A spacer 191 may be disposed on the bank 190. The spacer 191 may serve to support a mask during a process of manufacturing the light emitting layer 172. The spacer 191 may be formed of an organic film such as acryl resin, epoxy resin, phenolic resin, polyamide resin, polyimide resin and the like.

The light emitting layer 172 is formed on the pixel electrode 171. The light emitting layer 172 may include an organic material to emit light in a selected color. For example, the light emitting layer 172 may include a hole transporting layer, an organic material layer, and an electron transporting layer. The organic material layer may include a host and a dopant. The organic material layer may include a material that emits selected light, and may be formed using a phosphorescent material or a fluorescent material.

For example, the organic material layer of the light emitting layer 172 in the first emission area EA1 emitting the light of the first color may be a phosphorescent material including a host material including carbazole biphenyl (CBP) or mCP (1,3-bis(carbazol-9-yl), and a dopant including at least one selected from the group consisting of PIQIr(acac)(bis(1-phenylisoquinoline) acetylacetonate iridium), PQIr(acac)(bis(1-phenylquinoline) acetylacetonate iridium), PQIr(tris(1-phenylquinoline) iridium)) and PtOEP (octaethylporphyrin platinum). Alternatively, the organic material layer of the light emitting layer 172 of the first emission area EA1 may be a fluorescent material including PBD:Eu(DBM)3(Phen) or Perylene, but the present disclosure is not limited thereto.

The organic material layer of the light emitting layer 172 in the fourth emission area EA4 and the second emission area EA2 emitting the light of the second color may be a phosphorescent material including a host material including CBP or mCP, and a dopant material including Ir(ppy)3(fac tris(2-phenylpyridine)iridium. Alternatively, the organic material layer of the light emitting layer 172 in the fourth emission area EA4 and the second emission area EA2 emitting the light of the second color may be a fluorescent material including tris(8-hydroxyquinolino)aluminum (Alq3), but the present disclosure is not limited thereto.

The organic material layer of the light emitting layer 172 in the third emission area EA3 emitting the light of the third color may be a phosphorescent material including a host material including CBP or mCP, and a dopant material including (4,6-F2ppy)2Irpic or L2BD111, but the present disclosure is not limited thereto.

The common electrode 173 is formed on the light emitting layer 172. The common electrode 173 may be formed to cover the light emitting layer 172. The common electrode 173 may be a common layer which is commonly formed in the emission areas EA1, EA2, EA3, and EA4. A capping layer may be formed on the common electrode 173.

In the top emission structure, the common electrode 173 may be formed of a transparent conductive material (TCO) such as ITO or IZO capable of transmitting light or a semi-transmissive conductive material such as magnesium (Mg), silver (Ag), or an alloy of magnesium (Mg) and silver (Ag). When the common electrode 173 is formed of a semi-transmissive conductive material, the light emission efficiency can be increased due to a micro-cavity effect.

The encapsulation layer ENC may be formed on the light emitting element layer EML. The encapsulation layer ENC may include at least one inorganic film TFE1 and TFE2 to prevent oxygen or moisture from permeating into the light emitting element layer EML. In addition, the encapsulation layer ENC may include at least one organic film to protect the light emitting element layer EML from foreign substances such as dust. For example, the encapsulation layer ENC may include a first encapsulation inorganic film TFE1, an encapsulation organic film TFE2, and a second encapsulation inorganic film TFE3.

The first encapsulation inorganic film TFE1 may be disposed on the common electrode 173, the encapsulation organic film TFE2 may be disposed on the first encapsulation inorganic film TFE1, and the second encapsulation inorganic film TFE3 may be disposed on the encapsulation organic film TFE2. The first encapsulation inorganic film TFE1 and the second encapsulation inorganic film TFE3 may be formed of multiple films in which one or more inorganic films of a silicon nitride layer, a silicon oxynitride layer, a silicon oxide layer, a titanium oxide layer and an aluminum oxide layer are alternately stacked. The encapsulation organic film TFE2 may be an organic film such as acryl resin, epoxy resin, phenolic resin, polyamide resin, polyimide resin or the like.

The sensor electrode layer SENL is disposed on the encapsulation layer ENC. The sensor electrode layer SENL may include the sensor electrodes SE.

A third buffer film BF3 may be disposed on the encapsulation layer ENC. The third buffer film BF3 may be a layer having insulating and optical functions. The third buffer film BF3 may include at least one inorganic film. For example, the third buffer film BF3 may be formed of a multilayer in which one or more inorganic films of a silicon nitride layer, a silicon oxynitride layer, a silicon oxide layer, a titanium oxide layer and an aluminum oxide layer are alternately stacked. The third buffer film BF3 may be formed by a lamination process using a flexible material, a spin coating process using a solution-type material, a slit die coating process, or a deposition process. The third buffer film BF3 may be omitted.

First connection portions BE1 may be disposed on the third buffer film BF3. The first connection portions BE1 may be formed of a single layer containing molybdenum (Mo), titanium (Ti), copper (Cu), or aluminum (Al), or may be formed to have a stacked structure (Ti/Al/Ti) of aluminum and titanium, a stacked structure (ITO/Al/ITO) of aluminum and indium tin oxide (ITO), an Ag—Pd—Cu (APC) alloy, or a stacked structure (ITO/APC/ITO) of APC alloy and ITO.

A first sensor insulating film TINS1 may be disposed on the first connection portions BE1. The first sensor insulating film TINS1 may be a layer having insulating and optical functions. The first sensor insulating film TINS1 may be formed of an inorganic film, for example, a silicon nitride layer, a silicon oxynitride layer, a silicon oxide layer, a titanium oxide layer, or an aluminum oxide layer. The first sensor insulating film TINS1 may be formed by a lamination process using a flexible material, a spin coating process using a solution-type material, a slit die coating process, or a deposition process.

The sensor electrodes SE, i.e., driving electrodes TE and sensing electrodes RE may be disposed on the first sensor insulating film TINS1. In addition, dummy patterns DE may be disposed on the first sensor insulating film TINS1. The driving electrodes TE, the sensing electrodes RE, and the dummy patterns DE do not overlap the emission areas EA1, EA2, EA3, and EA4. The driving electrodes TE, the sensing electrodes RE, and the dummy patterns DE may be formed of a single layer containing molybdenum (Mo), titanium (Ti), copper (Cu), or aluminum (Al), or may be formed to have a stacked structure (Ti/Al/Ti) of aluminum and titanium, a stacked structure (ITO/Al/ITO) of aluminum and indium tin oxide (ITO), an Ag—Pd—Cu (APC) alloy, or a stacked structure (ITO/APC/ITO) of APC alloy and ITO.

A second sensor insulating film TINS2 may be disposed on the driving electrodes TE, the sensing electrodes RE, and the dummy patterns DE. The second sensor insulating film TINS2 may be a layer having an insulating function and an optical function. The second sensor insulating film TINS2 may include at least one of an inorganic film or an organic film. The inorganic film may be a silicon nitride layer, a silicon oxynitride layer, a silicon oxide layer, a titanium oxide layer, or an aluminum oxide layer. The organic film may include acryl resin, epoxy resin, phenolic resin, polyamide resin, or polyimide resin. The second sensor insulating film TINS2 may be formed by a lamination process using a flexible material, a spin coating process using a solution-type material, a slit die coating process, or a deposition process.

A heat dissipation layer HSL of the panel lower cover PB may be disposed on the bottom surface of the support substrate SSUB of the substrate SUB. The heat dissipation layer HSL may be formed of a metal thin film such as copper, nickel, ferrite, or silver that can shield electromagnetic waves and has excellent thermal conductivity.

FIG. 9 is a cross-sectional view of a boundary between an antenna area of a display device according to an embodiment and a non-display area adjacent thereto.

Referring to FIG. 9, a dam DAM surrounding the display area DA may be disposed in the non-display area NDA of the display panel 300. The dam DAM may include a first dam DAM1 of the encapsulation layer ENC and a second dam DAM2 disposed more outward than the first dam DAM1. The first dam DAM1 and the second dam DAM2 may be disposed on the second interlayer insulating film 142.

The first dam DAM1 may include a first sub-dam SDAM1, a second sub-dam SDAM2, and a third sub-dam SDAM3 which are sequentially stacked. The first sub-dam SDAM1 may be formed of the same material as the first organic film 160, the second sub-dam SDAM2 may be formed of the same material as the second organic film 180, and the third sub-dam SDAM3 may be formed of the same material as the bank 190.

The second dam DAM2 may include the first sub-dam SDAM1, the second sub-dam SDAM2, the third sub-dam SDAM3, and a fourth sub-dam SDAM4 which are sequentially stacked. The first sub-dam SDMA1 may be formed of the same material as the first organic film 160, and the second sub-dam SDAM2 may be formed of the same material as the second organic film 180. The third sub-dam SDAM3 may be formed of the same material as the bank 190, and the fourth sub-dam SDAM4 may be formed of the same material as the spacer 191 (see FIG. 22).

Referring to FIG. 9, the antenna electrode AE may include first to eighth antenna electrode layers AEL1 to AEL8. However, the embodiment of the present disclosure is not limited thereto, and the antenna electrode AE may include only some antenna electrode layers among the first to eighth antenna electrode layers AEL1 to AEL8.

The first antenna electrode layer AEL1 may be made of the same material and formed by the same process as the gate electrode TG (see FIG. 8) of the thin film transistor TFT (see FIG. 8) and the first capacitor electrode CAE1 (see FIG. 8).

The second antenna electrode layer AEL2 may be disposed on the first antenna electrode layer AEL1 exposed without being covered with the first interlayer insulating film 141 (see FIG. 8). The second antenna electrode layer AEL2 may be made of the same material and formed by the same process as the second capacitor electrode CAE2 (see FIG. 8).

The third antenna electrode layer AEL3 may be disposed on the second antenna electrode layer AEL2 exposed without being covered with the second interlayer insulating film 142 (see FIG. 8). The third antenna electrode layer AEL3 may be made of the same material and formed by the same process as the first connection electrode CE1 (see FIG. 8).

The fourth antenna electrode layer AEL4 may be disposed on the third antenna electrode layer AEL3. The fourth antenna electrode layer AEL4 may be made of the same material and formed by the same process as the second connection electrode CE2 (see FIG. 8).

The fifth antenna electrode layer AEL5 may be disposed on the fourth antenna electrode layer AEL4. The fifth antenna electrode layer AEL5 may be made of the same material and formed by the same process as the pixel electrode 171 (see FIG. 8).

The sixth antenna electrode layer AEL6 may be disposed on the fifth antenna electrode layer AEL5. The sixth antenna electrode layer AEL6 may be made of the same material and formed by the same process as the common electrode 173 (see FIG. 8).

The seventh antenna electrode layer AEL7 may be disposed on the sixth antenna electrode layer AEL6. The seventh antenna electrode layer AEL7 may be made of the same material and formed by the same process as the first connection portion BE1 (see FIG. 8) of the sensor electrode layer SENL.

The eighth antenna electrode layer AEL8 may be disposed on the seventh antenna electrode layer AEL7. The eighth antenna electrode layer AEL8 may be made of the same material and formed by the same process as the driving electrode TE (see FIG. 8), the sensing electrode RE (see FIG. 8), and/or the dummy pattern (not shown) of the sensor electrode layer SENL.

A through hole CT may pass through the first substrate SUB1, the first buffer film BF1, the second substrate SUB2, and the second buffer film BF2 of the substrate SUB. In addition, the through hole CT may pass through the gate insulating film 130.

The antenna electrode AE may be in contact with the feed line FL through the through hole CT. Here, the feed line FL may mean the first feed line FL1 or the second feed line FL2 described with reference to FIG. 7.

The antenna pad APD electrically connected to the feed line FL may be disposed at the end of the feed line FL. The feed line FL and the antenna pad APD may be disposed on the bottom surface of the first substrate SUB1 of the substrate SUB. Since the antenna area AA is bent and disposed under the main region MA, the support substrate SSUB of the substrate SUB may be removed from the antenna area AA where the feed line FL is disposed.

The antenna pad APD may be connected to the antenna circuit board 340 using an anisotropic conductive film (ACF) including a conductive ball CB and a conductive adhesive member CAM such as an anisotropic conductive adhesive.

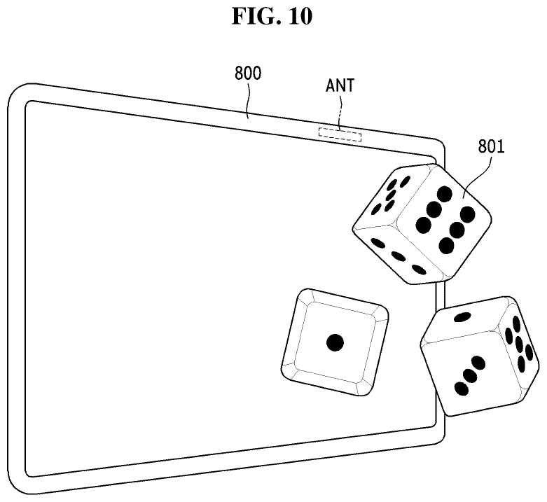

FIG. 10 is a diagram illustrating an example in which a display device, 800, according to an embodiment is implemented as a non-glasses type light field display (LFD).

An LFD is a three-dimensional (3D) display that creates a 3D image, e.g., 801, by generating a light field expressed as a vector distribution (intensity and direction) of light in space by a flat display and optical elements. In this case, the light field refers to a kind of field of light similar to the concept of a vector function, an electric field, a magnetic field and five dimensions (x, y, z, θ, and q), which represent the direction and intensity of light at all points in 3D space.

Unlike two-dimensional (2D) displays, the light field displays express different information according to the viewing direction. The light field display allows the user to view the depth (i.e., the depth location within a 3D image) and sides of objects, enabling more natural 3D images, so that it may be applied to an augmented reality (AR) technique and the like.

A light field may be implemented in various ways. For example, the light field may be implemented by a method of generating a light field in multiple directions using multiple projectors, a method of controlling the direction of light using a diffraction grating, a method of using two or more panels to control the direction and intensity (luminance) of light according to the combination of pixels, a method of controlling the direction of light using a pinhole or a barrier, and a method of controlling the refraction direction of light through a microlens array.

According to an embodiment, the display device 800 implemented as a non-glasses type LFD may include an antenna ANT within a non-display area, such as the antenna ANT including antennas ANT1 and ANT2 described earlier. The antenna ANT senses an RF signal reflected by an object (body). Here, the antenna ANT may be configured to sense information such as a distance to an object (body) and a moving speed and direction thereof using a radar technique which may include beamforming and beam steering as described earlier.

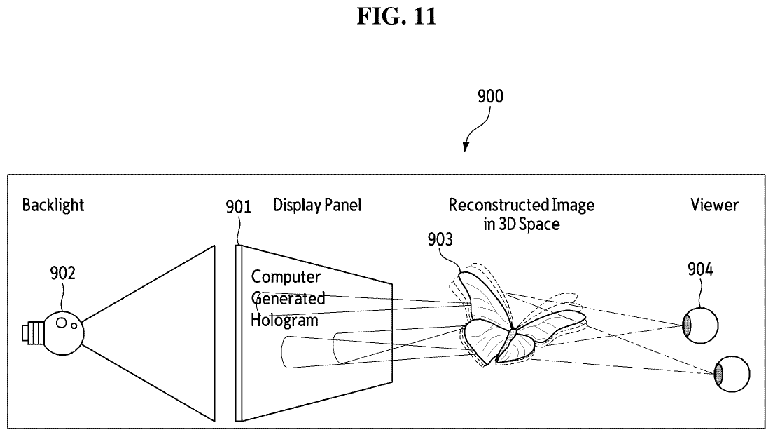

FIG. 11 is a diagram illustrating an example in which a display device according to an embodiment is implemented as a volumetric display.

Referring to FIG. 11, a display device 900 according to an embodiment may be implemented as a variable focus type volumetric display.

The volumetric display is a technique that creates images directly in 3D space, using volumetric pixels (voxels), which are pixels in space to create 3D images in physical 3D space. The volumetric displays include screen motion type, plasma emission type, variable focus type, particle trap type, and the like.

The screen motion type rotates or reciprocates a screen at high speed and continuously projects cross-sectional images of a 3D object synchronized to the moving speed, thereby allowing the user to view 3D images by the afterimage effect thus obtained.

The plasma emission type focuses a high-power laser on a point in space, plasmatizes the surrounding air to generate light, and creates a 3D image by organizing a number of light emitting points in the space through high-speed scanning.

The variable focus type creates 3D images by changing the focal length of an image at high speed through a varifocal lens to form voxels that are in focus at different locations in space.

The particle trap type traps and moves very light and small particles with a laser based on the photophoretic trap effect of a laser, irradiates external light according to the movement of the particles to scatter the light, and creates 3D images in space by the afterimage effect of the scattered light.

The display device 900 is a volumetric display using a 3D holographic method that shoots light into space. The 3D holographic method creates a stereoscopic flow of light by shooting light into real space. The volumetric display may allow a user 904 to observe an object from any viewpoint regardless of movement of the user 904.

Holography creates 3D images through the interference phenomenon of light, and they may be created digitally. The digital method reproduces 3D images by creating interference patterns through mathematical calculation and processing, and recording them as data.

A digital holographic display uses coherent light sources to create a 3D image of the image being recorded in real time on the display. Coherence is a property of light like a long thread. Fluorescent lamps, incandescent lamps, and LED lights do not have coherence, and they have a property in which light like short threads spreads in all directions.

Holography by the display device 900 creates an image through the principle that light rays meet and “interfere” with each other. “Dots” of bright light are created at positions where light rays “constructively interfere.” When thousands or tens of thousands of these “dots” are made into a desired image pattern, a 3D image floating in space is created. The dots of light made by such “interference” may be considered to play the role of pixels.

For the display device 900 to create a 3D image 903, a designated pattern is displayed on a panel 901 and light from a backlight 902 is allowed to pass through this pattern. The designated pattern may be made by first determining a 3D image to be created by the display device 900 and inversely calculating the 3D image based on a mathematical principle.

According to an embodiment, the display device 900 implemented as a variable focus type volumetric display includes an antenna ANT (not shown in FIG. 9), which senses an RF signal reflected by an object (body). Here, the antenna ANT is configured to sense information such as a distance to an object (body) and a moving speed and direction thereof. The antenna ANT may include antennas ANT1 and ANT2 described earlier.

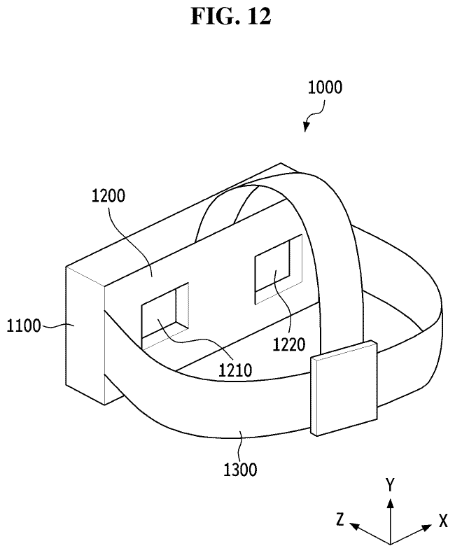

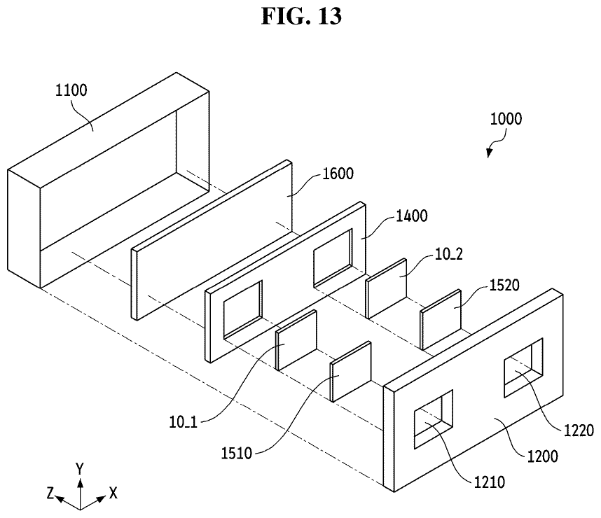

FIG. 12 is a perspective view illustrating a head mounted display according to an embodiment. FIG. 13 is an exploded perspective view illustrating an example of the head mounted display of FIG. 12.

Referring to FIGS. 12 and 13, a head mounted display 1000 according to an embodiment includes a first display device 10_1, a second display device 10_2, a display device housing 1100, a housing cover 1200, a first eyepiece 1210, a second eyepiece 1220, a head mounted band 1300, a middle frame 1400, a first optical member 1510, a second optical member 1520, and a control circuit board 1600.

The first display device 10_1 provides an image to the user's left eye, and the second display device 10_2 provides an image to the user's right eye. Each of the first display device 10_1 and the second display device 10_2 may be substantially the same as the display device 10 described in conjunction with FIGS. 1 to 6, and the description of the first display device 10_1 and the second display device 10_2 will be omitted.

The first optical member 1510 may be disposed between the first display device 10_1 and the first eyepiece 1210. The second optical member 1520 may be disposed between the second display device 10_2 and the second eyepiece 1220. Each of the first optical member 1510 and the second optical member 1520 may include at least one convex lens.

The middle frame 1400 may be disposed between the first display device 10_1 and the control circuit board 1600 and between the second display device 10_2 and the control circuit board 1600. The middle frame 1400 serves to support and fix the first display device 10_1, the second display device 10_2, and the control circuit board 1600.

The control circuit board 1600 may be disposed between the middle frame 1400 and the display device housing 1100. The control circuit board 1600 may be connected to the first display device 10_1 and the second display device 10_2 through the connector. The control circuit board 1600 may convert an image source inputted from the outside into the digital video data, and transmit the digital video data to the first display device 10_1 and the second display device 10_2 through the connector.

The control circuit board 1600 may transmit the digital video data corresponding to a left-eye image optimized for the user's left eye to the first display device 10_1, and may transmit the digital video data corresponding to a right-eye image optimized for the user's right eye to the second display device 10_2. Alternatively, the control circuit board 1600 may transmit the same digital video data to the first display device 10_1 and the second display device 10_2.

The display device housing 1100 serves to accommodate the first display device 10_1, the second display device 10_2, the middle frame 1400, the first optical member 1510, the second optical member 1520, and the control circuit board 1600. The housing cover 1200 is disposed to cover one open surface of the display device housing 1100. The housing cover 1200 may include the first eyepiece 1210 at which the user's left eye is located and the second eyepiece 1220 at which the user's right eye is located. FIGS. 12 and 13 illustrate that the first eyepiece 1210 and the second eyepiece 1220 are disposed separately, but the embodiment of the present disclosure is not limited thereto. The first eyepiece 1210 and the second eyepiece 1220 may be combined into one.

The first eyepiece 1210 may be aligned with the first display device 10_1 and the first optical member 1510, and the second eyepiece 1220 may be aligned with the second display device 10_2 and the second optical member 1520. Therefore, the user may view, through the first eyepiece 1210, the image of the first display device 10_1 magnified as a virtual image by the first optical member 1510, and may view, through the second eyepiece 1220, the image of the second display device 10_2 magnified as a virtual image by the second optical member 1520.

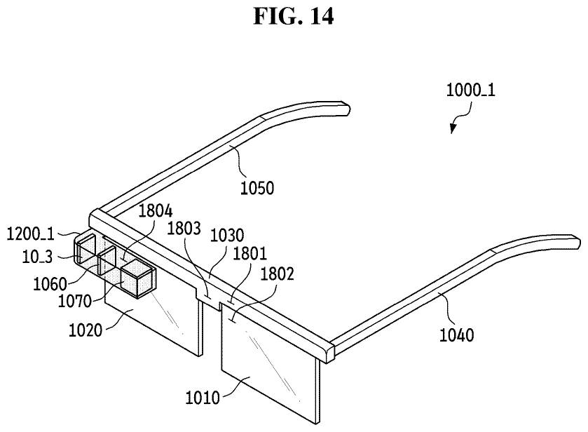

The head mounted band 1300 serves to secure the display device housing 1100 to the user's head such that the first eyepiece 1210 and the second eyepiece 1220 of the housing cover 1200 remain located on the user's left and right eyes, respectively. When the display device housing 1200 is implemented to be lightweight and compact, the head mounted display 1000 may be provided with, as shown in FIG. 14, an eyeglass frame instead of the head mounted band 1300.

In addition, the head mounted display 1000 may further include a battery for supplying power, an external memory slot for accommodating an external memory, and an external connection port and a wireless communication module for receiving an image source. The external connection port may be a universe serial bus (USB) terminal, a display port, or a high-definition multimedia interface (HDMI) terminal, and the wireless communication module may be a 5G communication module, a 4G communication module, a Wi-Fi module, or a Bluetooth module.

FIG. 14 is a perspective view illustrating a head mounted display according to an embodiment.

Referring to FIG. 14, a head mounted display 1000_1 according to an embodiment may be a glasses-type display in which a display device housing 1200_1 is implemented in a lightweight and compact manner. The head mounted display 1000_1 according to an embodiment may include a display device 10_3, a left eye lens 1010, a right eye lens 1020, a support frame 1030, temples 1040 and 1050, an optical member 1060, an optical path changing member 1070, and the display device housing 1200_1.

The display device housing 1200_1 may include the display device 10_3, the optical member 1060, and the optical path changing member 1070. The image displayed on the display device 10_3 may be magnified by the optical member 1060, and may be provided to the user's right eye through the right eye lens 1020 after the optical path thereof is changed by the optical path changing member 1070. As a result, the user may view an augmented reality image, through the right eye, in which a virtual image displayed on the display device 10_3 and a real image seen through the right eye lens 1020 are combined.

FIG. 14 illustrates that the display device housing 1200_1 is disposed at the right end of the support frame 1030, but the present disclosure is not limited thereto. For example, the display device housing 1200_1 may be disposed at the left end of the support frame 1030, and in this case, the image of the display device 10_3 may be provided to the user's left eye. Alternatively, the display device housing 1200_1 may be disposed at both the left and right ends of the support frame 1030, and in this case, the user may view the image displayed on the display device 10_3 through both the left and right eyes.

According to an embodiment, the head mounted display 1000_1 may have an antenna disposed on a part of the glasses frame (e.g., one side of the support frame 1030) surrounding the lenses 1010 and 1020 as indicated by reference numeral 1801.

According to an embodiment, the head mounted display 1000_1 may have an antenna disposed on a part of the lens 1010, 1020, as indicated by reference numeral 1802.

According to an embodiment, the head mounted display 1000_1 may have an antenna disposed near the center of the support frame 1030, as indicated by reference numeral 1803.

According to an embodiment, the head mounted display 1000_1 may have an antenna inside the display device housing 1200_1, as indicated by reference numeral 1804.

According to an embodiment, the head mounted display 1000_1 may have antennas disposed at the positions as indicated by the reference numerals 1801, 1802, 1803, and 1804, and allow the antennas to sense RF signals reflected by an object (body). The antenna of the head mounted display 1000_1 is configured to sense information such as a distance to an object (body) and a moving speed and direction thereof.

Although not shown, the antenna may be an attachable antenna built into the display device 10. In this case, the antenna may be made of a general metal and a transparent metal, or may be configured with a transparent printed circuit board (PCB) to perform an antenna operation.

According to an embodiment, the antenna may be implemented in the form of a print on the lens. In this case, the antenna may be made of a transparent metal as well as a general metal.

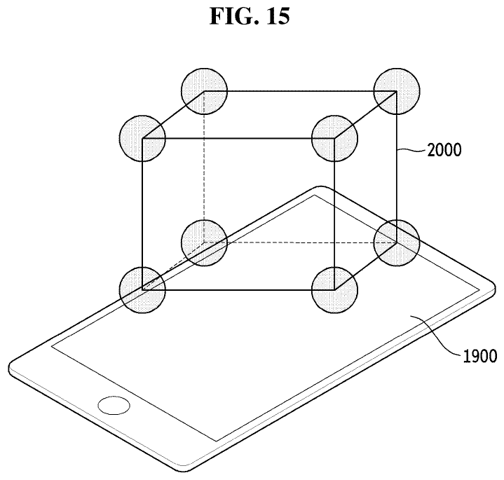

FIG. 15 is a diagram illustrating an example in which a display device according to an embodiment is a holographic display.

Referring to FIG. 15, a display device 1900 according to an embodiment may be implemented as a holographic display.

Holography is a technique that creates images by reproducing wavefronts using the diffraction effect of light, and may be divided into analog holography and digital holography.

The analog holography splits light into two paths and then records patterns, which are generated by interference between object light directly shone and reflected on the object and reference light reflected from a mirror, onto a photographic plate with a photosensitive material. When the same reference light is shone on the photographic plate on which the interference pattern was recorded, the image of the object is reproduced, so that the user may view the holographic image. Since the light used in analog holography needs to cause interference, it may be a laser beam with coherence (a property that may cause interference with the same frequency and constant phase difference).

Because digital holography reproduces images using a computer, it may also be referred to as computer generated holography (CGH). Digital holography creates 3D images by using a spatial light modulator (SLM), which may control the amplitude or phase of light, instead of the photographic plate. Digital holography creates an interference pattern image of a 3D object to be displayed by mathematical calculation using a computer, records it in the SLM, and then displays a hologram image by emitting coherent light.

According to an embodiment, the display device 1900 implemented as a holographic display includes an antenna, which senses an RF signal reflected by an object (body). Here, the antenna is configured to sense information such as a distance to an object (body) and a moving speed and direction thereof.

According to an embodiment, the display device 1900 may set 3D touch coordinates to detect a user's touch or user's gesture with respect to 3D space. In order to set the 3D touch coordinates, the display device 1900 may display a designated guide image for setting 3D touch coordinates in 3D space.

Hereinafter, the operation of displaying the designated guide image for setting 3D touch coordinates in 3D space in order to set the 3D touch coordinates, and detecting a user's touch or user's gesture with respect to 3D space by using it, performed by the display device 1900 according to an embodiment, will be described in detail.

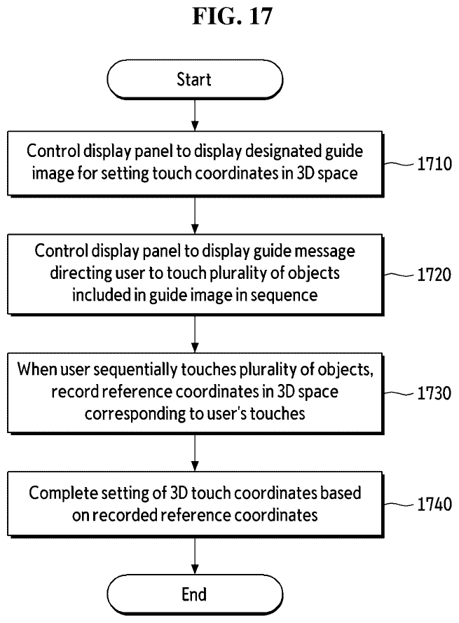

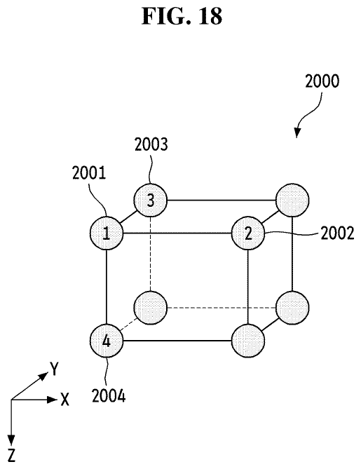

FIG. 16 is a diagram illustrating an example in which a display device according to an embodiment is a glasses type display device. FIG. 17 is a flowchart illustrating a method for driving a display device according to an embodiment. FIG. 18 is a conceptual diagram illustrating a method of setting reference coordinates for 3D touch detection by a display device according to an embodiment. Although the display device 1600 shown in FIG. 16 is a glasses type display device, the present disclosure is not limited thereto. For example, the display device 1600 may be the various types of display devices described with reference to FIGS. 1 to 15. It may be a light field display (LFD), a volumetric display, or a holographic display.

Hereinafter, a method for driving a display device according to an embodiment will be described with reference to FIGS. 16 to 18.

Referring to FIGS. 16 and 17, the processor 410 (see FIG. 4) of a display device 2100 according to an embodiment controls the display panel 300 (see FIG. 1) to display a designated guide image 2000 for setting touch coordinates in 3D space, in operation 1710.

According to an embodiment, the guide image 2000 includes at least a portion of a cube-shaped image.

According to an embodiment, as shown in FIG. 18, the guide image 2000 includes a first object 2001 corresponding to a first vertex of a cube shape (“cube”) and representing the origin (in an XYZ cartesian coordinate system) in the 3D space, a second object 2002 corresponding to a second vertex of the cube and representing an X coordinate from the origin in the 3D space, a third object 2003 corresponding to a third vertex of the cube and representing a Y coordinate from the origin in the 3D space, and a fourth object 2004 corresponding to a fourth vertex of the cube and representing a Z coordinate from the origin in the 3D space.

Referring to FIGS. 16 and 17, in operation 1720, the processor 410 (see FIG. 4) of the display device 2100 according to an embodiment controls the display panel 300 (see FIG. 1) to display a guide message 2016 directing the user to touch a plurality of objects included in the guide image 2000 in sequence.

The guide message includes a message 2016 (e.g., “TOUCH OBJECTS 1, 2, 3, 4 IN ORDER”) that instructs the user to touch the first object 2001, the second object 2002, the third object 2003, and the fourth object 2004 in a predetermined sequence.

The user may sequentially touch the first object 2001, the second object 2002, the third object 2003, and the fourth object 2004 in the 3D space according to the guidance of the guide message 2016.

Referring to FIGS. 16 and 17, when the user sequentially touches the plurality of objects, the processor 410 (see FIG. 4) of the display device 2100 according to an embodiment records reference coordinates in a memory (e.g., 1120 of FIG. 20) in the 3D space corresponding to the user's touches, in operation 1730.

According to an embodiment, the processor 410 sets the origin of the 3D space based on detecting, using the antenna ANT, that the user has touched the first object 2001.

According to an embodiment, the processor sets an X reference coordinate on the X coordinate based on detecting, using the antenna ANT, that the user has touched the second object 2002.

According to an embodiment, the processor sets a Y reference coordinate on the Y coordinate based on detecting, using the antenna ANT, that the user has touched the third object 2003.

According to an embodiment, the processor sets a Z reference coordinate on the Z coordinate based on detecting, using the antenna ANT. that the user has touched the fourth object 2004.

Referring to FIGS. 16 and 17, the processor 410 (see FIG. 4) of the display device 2100 according to an embodiment completes setting of the 3D touch coordinates based on the recorded reference coordinates, in operation 1740.

After the reference coordinates are set, the display device 2100 may detect a user's touch or user's gesture with respect to the 3D space based on the set reference coordinates.

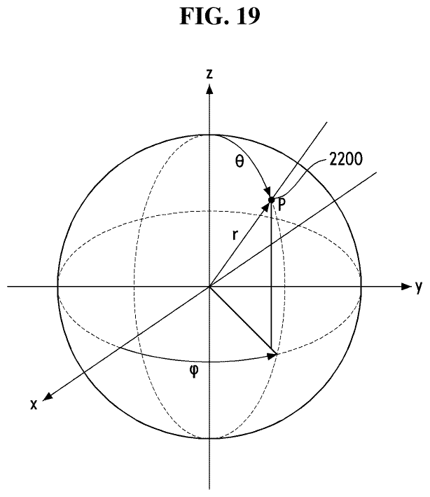

FIG. 19 is an example of a coordinate system in which the display device 2100 according to an embodiment performs 3D touch detection.

According to an embodiment, after the reference coordinates are set, the display device 2100 may detect a user's touch or user's gesture with respect to the 3D space based on the set reference coordinates.

For example, when the user touches a specific location 2200 in 3D space, the display device 2100 may calculate X, Y, and Z coordinates, an r value, a θ value, and a φ value of the specific location 2200 corresponding to the user's touch based on the set reference coordinates.

While the display panel 300 is described above to include an antenna ANT to detect touch input coordinates in the 3D space based on reflected RF signals, the display panel 300 may alternatively detect the touch input coordinates by including a front-facing camera (not shown) in the non-display area to capture images of a user's touch input (e.g., the user's finger or held object). In this case, the processor 410 may be communicatively coupled to the camera and analyze the captured images to detect the touch input coordinates in correspondence with the guide image. The camera may be a stereoscopic camera that measures depths of objects in an image field.

FIG. 20 is a block diagram illustrating an electronic device, 3000, according to an embodiment of the present inventive concept. Referring to FIG. 20, the electronic device 3000 may output various information (e.g., images, text, music, etc.) through a display module 1140, which, for example, may correspond to the display device 10 shown in FIG. 1. When a processor 1110 (e.g., corresponding to the processor 410 of FIG. 4) executes an application stored in a memory 1120, the display module 1140 may provide application information to a user through a display panel 1141 (e.g., corresponding to the display panel 300 of FIG. 1).

In some embodiments, the electronic device 3000 may be configured as a smartphone, camera, smart TV, monitor, smartwatch, tablet, automotive display, or AR/VR headset. For example, the electronic device 3000 may be a smartphone including a touch-sensitive display area DA for interaction and a non-display area NDA including sensors and circuits for enhanced functionality. For example, the electronic device 3000 may be a television or monitor including a large display area DA for high-resolution video playback and a non-display area NDA incorporating driving circuits or connectivity modules for external inputs. For example, the electronic device 3000 may be a smartwatch including a display area DA optimized for compact and high-clarity visuals and a non-display area NDA integrating biometric sensors for health monitoring. In some cases, the electronic device 3000 be an AR/VR headset.

In some embodiments, memory 1120 may store information such as software codes for operating an application program 1123. The application program 1123 may include software designed to execute specific tasks or provide functionality to a user. The application program 1123 may operate under the control of the processor 1110 and utilizes data stored in the memory 1120 to deliver a wide range of features, such as productivity tools, multimedia streaming and playback, file or mail deliveries or communication services. The application program 1123 interacts seamlessly with a user interface 1161 or touch screen 1142, allowing a user to launch, navigate, and utilize the program through user inputs such as touch, tap, gesture, or voice interaction. The touch inputs and gestures may be 3D inputs based on the 3D reference coordinate detection described above in connection with FIGS. 16-19.

Upon user selection of an application via touch screen 1142 or user interface 1161, the processor 1110 may execute the application program 1123 corresponding to the selected application retrieved from the memory 1120 to perform functionalities of the application. For example, when a user selects a camera application by tapping the icon (or a camera application icon) presented on the display panel 1141, the processor 1110 activates a camera module. The processor 1110 may transmit image data corresponding to a captured image acquired through the camera module to the display module 1140. The display module 1140 may display an image corresponding to the captured image through the display panel 1141.

As another example, when a user wishes to make a phone call, the user taps the telephone icon displayed on the display module 1140, or touches a telephone icon in the 3D space, and the processor 1110 may execute a phone application program stored in the memory 1120. A telephone keypad may be presented on the display panel 1141 or in the 3D space for the user to enter a phone number to call.

As another example, the display module 1140 may be integrated into an electronic device 3000, such as a laptop computer, smart TV, or tablet. A user wishing to access a multimedia streaming application (e.g., to watch a music video or movie) can do so by tapping the corresponding icon or touching the corresponding icon in the 3D space. This action activates the application, allowing the user to view the streamed content.**The processor 1110 may include a main processor 1111 and an auxiliary or coprocessor 1112. The main processor 1111 may include a central processing unit (CPU). The main processor 1111 may further include one or more of a graphics processing unit (GPU), a communication processor (CP), and an image signal processor (ISP).

The coprocessor 1112 may include a controller 1112-1. The controller 1112-1 may include an interface conversion circuit and a timing control circuit. The controller 1112-1 may receive an image signal from the main processor 1111, convert the data format of the image signal to match the interface specifications with the display module 1140, and output image data. The controller 1112-1 may output various control signals to drive the display module 1140. For example, the controller 1112-1 may drive the display module 1140 to display the icon on the display screen or form it in the 3D space suitable for selection by a user to cause execution of an application program 1123.

The memory 1120 may store one or more application programs 1123 and various data used by at least one component (for example, the processor 1110 or the user interface 1161) of the electronic device 3000 and input data or output data for commands related thereto. For example, a camera application program, a GPS application program, an augmented reality and virtual reality application program, and other application programs that can be executed by the processor 1110 upon selection of corresponding icons presented on the display screen (or in the 3D space) via the touch screen 1142 or touch input in the 3D space by the user. In addition, various setting data corresponding to user settings may be stored in the memory 1120. The memory 1120 may include volatile memory 1121 and non-volatile memory 1122.

The display module 1140 may output visual information (images) to the user. The display module 1140 may include the display panel 1141, a gate driver, the source driver, a voltage generation circuit, and a touch screen 1142. The display module 1140 may further include a window, a chassis, and a bracket to protect the display panel 1141. The display module 1140 may include at least a part of the configuration of the display device shown in FIG. 1.

The user interface 1161 serves as the interaction medium between a user and the electronic device 3000. The user interface 1161 may detect an input by a part (e.g., finger) of a user's body or an input by a pen or a mouse, and generate an electric signal or data value corresponding to the input. The user interface 1161 includes the fingerprint sensor 1162, the input sensor 1163, and a digitizer 1164.

The fingerprint sensor 1162 may sense a fingerprint for biometric recognition of the user and may also measure one or more biological signals such as blood pressure, moisture, or body mass.

The input sensor 1163 may sense user interactions including touch on the touch screen, touch input in the 3D space, tap, gesture, motion, spoken command, and eye movement. Although shown separately in FIG. 20, the input sensor 1163 may include the mobile communication unit 360, the antenna driving circuit 350 and the antennas ANT1 and ANT2 described above for detecting 3D touch inputs under the control of the processor 1110. The input sensor 1163 may further include optical sensors for image capture, eye tracking, or motion and gesture detection. Optical sensors may be infrared or semiconductor photodetectors. The input sensor 1163 includes audio and acoustic sensors, which may be MEMS microphones for voice recognition or sound-based interaction. The audio and acoustic sensors can be installed as part of the user interface 1161 or embedded in the display panel 1141.

The digitizer 1164 may generate a data value corresponding to coordinate information of input by a pen or a mouse or a user's gesture in the 3D space to control movement of an onscreen cursor or a cursor in the 3D space. The digitizer 1164 may generate a change in electromagnetic field energy due to the input as the data value. The digitizer may detect an input by a passive pen or transmit and receive data with an active pen or a remote.

At least one of the fingerprint sensor 1162, the input sensor 1163, or the digitizer 1164 may be implemented as a sensor layer formed on the top layer of the display panel 1141 through a continuous process with a process of forming elements (for example, the light emitting element, the transistor, and the like) included in the display panel 1141.**In addition, the user interface 1161 may further include, for example, a gesture sensor, a gyro sensor that senses rotational movements, an acceleration sensor to track translational movement, a grip sensor, a pressure sensor, a proximity sensor, a color sensor, an infrared (IR) emitter and camera sensor for tracking gaze direction and eye movements, a temperature sensor, or a light sensor. For example, the gyro sensor, acceleration sensor, and infrared emitter and camera may be particularly suitable for AR/VR headset functions.

The touch screen 1142 includes touch sensors embedded in semiconductor layers of the display panel 1141 to sense pressure applied to the top layer (screen) of the display panel 1141. The touch sensors can be a capacitive or a resistive type. The touch screen 1142 may serve as the primary interface for the user to select and navigate applications, control, and interact with the electronic device 3000.

Examples of the display panel 1141 (or “display”) may include a liquid crystal display panel, an organic light emitting display panel, or an inorganic light emitting display panel, but the type of the display panel 1141 is not particularly limited. The display panel 1141 may be of a rigid type or a flexible type that can be rolled or folded. The display module 1140 may further include a supporter, bracket, heat dissipation member, and the like that support the display panel 1141.

The power source module 1150 may supply power to the components of the electronic device 3000. The power source module 1150 may include a battery that charges the power source voltage. The battery may include a non-rechargeable primary battery or a rechargeable secondary battery or fuel cell. The power source module 1150 may include a power management integrated circuit (PMIC). The PMIC may supply optimized power source to each of the components described above including the display module 1140.

In concluding the detailed description, those skilled in the art will appreciate that variations and modifications can be made to the disclosed embodiments without departing from the principles of the present disclosure. Therefore, the disclosed embodiments of the inventive concept are used in a generic and descriptive sense only and not for purposes of limitation.

What is claimed is:

1. A display device comprising:
a display panel; and
a processor configured to:
control the display panel to display a designated guide image for setting three-dimensional (3D) touch coordinates in 3D space,
control the display panel to display a guide message directing a user to touch a plurality of objects included in the guide image in sequence,
when the user sequentially touches the plurality of objects, record reference coordinates in the 3D space in a memory, corresponding to the user's touches, and
based on the recorded reference coordinates, complete setting of 3D touch coordinates.

2. The display device of claim 1, wherein the guide image comprises at least a portion of a cube-shaped image.

3. The display device of claim 2, wherein the guide image comprises:
a first object corresponding to a first vertex of the cube-shaped image and representing an origin, in an XYZ cartesian coordinate system, in the 3D space;
a second object corresponding to a second vertex of the cube-shaped image and representing an X coordinate from the origin in the 3D space;
a third object corresponding to a third vertex of the cube-shaped image and representing a Y coordinate from the origin in the 3D space; and
a fourth object corresponding to a fourth vertex of the cube-shaped image and representing a Z coordinate from the origin in the 3D space.

4. The display device of claim 3, wherein the guide message comprises instructions for the user to touch the first object, the second object, the third object, and the fourth object in a predetermined order.

5. The display device of claim 4, further including an antenna circuit board coupled to the processor, wherein:
the display panel includes a display area, and a non-display area including an antenna connected to the antenna circuit board; and
the processor sets the origin of the 3D space based on detecting, from a signal reflected from the user and received by the antenna, that the user has touched the first object.

6. The display device of claim 4, further including an antenna circuit board coupled to the processor, wherein:
the display panel includes a display area, and a non-display area including an antenna connected to the antenna circuit board; and
the processor sets an X reference coordinate as the X coordinate based on detecting, from a signal reflected from the user and received by the antenna, that the user has touched the second object.

7. The display device of claim 6, wherein the processor sets a Y reference coordinate on the Y coordinate based on detecting, from a further signal reflected from the user and received by the antenna, that the user has touched the third object.

8. The display device of claim 7, wherein the processor sets a Z reference coordinate on the Z coordinate based on detecting, from another signal reflected from the user and received by the antenna, that the user has touched the fourth object.

9. The display device of claim 1, wherein the display device is a glasses-type display.

10. The display device of claim 1, wherein the display device is a non-glasses type light field display (LFD).

11. The display device of claim 1, wherein the display device is a holographic display.

12. The display device of claim 1, wherein the display device is a variable focus type volumetric display.

13. A method for operating a display device comprising a display panel, the method comprising:
controlling, by a processor, the display panel to display a designated guide image for setting three-dimensional (3D) touch coordinates in 3D space;
controlling, by the processor, the display panel to display a guide message directing a user to touch a plurality of objects included in the guide image in sequence;
recording, by the processor to a memory, reference coordinates in the 3D space corresponding to the user's touches when the user sequentially touches the plurality of objects; and
completing, by the processor, setting of 3D touch coordinates based on the recorded reference coordinates.

14. The method of claim 13, wherein the guide image comprises at least a portion of a cube-shaped image.

15. The method of claim 14, wherein the guide image comprises:
a first object corresponding to a first vertex of the cube-shaped image and representing an origin in the 3D space;
a second object corresponding to a second vertex of the cube-shaped image and representing, in an XYZ cartesian coordinate system, an X coordinate from the origin in the 3D space;
a third object corresponding to a third vertex of the cube-shaped image and representing a Y coordinate from the origin in the 3D space; and
a fourth object corresponding to a fourth vertex of the cube-shaped image and representing a Z coordinate from the origin in the 3D space.

16. The method of claim 15, wherein the guide message comprises instructions for the user to touch the first object, the second object, the third object, and the fourth object in a predetermined order.

17. The method of claim 16, further comprising setting, by the processor, the origin of the 3D space based on detecting, using an antenna within the display panel. that the user has touched the first object.

18. The method of claim 16, further comprising setting, by the processor, an X reference coordinate on the X coordinate based on detecting, using an antenna within the display panel, that the user has touched the second object.

19. A display device comprising:
a display panel comprising a display area and a non-display area outside the display area, the non-display area including an antenna;
an antenna circuit board connected to the antenna; and
a processor connected to the antenna circuit board and configured to:
control the display panel to display a designated guide image for setting three-dimensional (3D) touch coordinates in 3D space;
control the display panel to display a guide message directing a user to touch a plurality of objects included in the guide image in sequence;
control the antenna circuit board to transmit radio frequency (RF) signals through the antenna; and
when the user sequentially touches the plurality of objects, receive signal information from the antenna circuit board corresponding to the transmitted RF signals which are reflected from the user and received by the antenna, and based on the signal information, record reference coordinates in the 3D space in a memory, corresponding to the user's touches.

20. The display device of claim 19, wherein the antenna is a multi-element array antenna that forms steerable beams controlled by the processor.
